(19) United States
(12) Patent Application Publication
(10) Pub. No.: US 2026/0012611 A1
(43) Pub. Date: Jan. 8, 2026

(54) MOTION VECTOR PREDICTOR DERIVATION FROM SPATIAL AND TEMPORAL MOTION VECTORS FOR VIDEO CODING

(71) Applicant: QUALCOMM Incorporated, San Diego, CA (US)

(72) Inventors: Jian-Liang Lin, Su'ao Township (TW); Po-Han Lin, Taipei (TW); Zhi Zhang, Munich (DE); Vadim Seregin, San Diego, CA (US); Marta Karczewicz, San Diego, CA (US)

(21) Appl. No.: 19/250,593

(22) Filed: Jun. 26, 2025

Related U.S. Application Data
(60) Provisional application No. 63/667,901, filed on Jul. 5, 2024.

(51) Int. Cl. H04N 19/137; H04N 19/159; H04N 19/176

(52) U.S. Cl. CPC H04N 19/137; H04N 19/159; H04N 19/176

(57) ABSTRACT

A video coder receives a block to be decoded using bi-prediction, determines a spatial motion vector for the block, determines an additional motion vector based on the spatial motion vector, wherein the additional motion vector is a temporal motion vector or a chained motion vector predictor (CMVP), generates a hybrid spatial-temporal motion vector based on the spatial motion vector and the additional motion vector, and codes the block of video data using bi-prediction and the hybrid spatial-temporal motion vector.

This application claims the benefit of U.S. Provisional Application No. 63/667,901, filed Jul. 5, 2024, the entire content of which is incorporated by reference herein.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for inter prediction. More specifically, this disclosure describes techniques for motion vector predictor derivation, including using both spatial motion vectors and temporal motion vectors when deriving motion vector predictors for bi-prediction. Such a hybrid spatial-temporal motion vector predictor may enhance the efficiency and accuracy of video compression.

In one example the disclosure, a video coder may be configured to receive a block of video data to be coded using bi-prediction and derive a hybrid motion vector predictor. The hybrid motion vector predictor is generated by combining motion vectors from two sources: one derived from a spatial motion vector and the other from a temporal motion vector predictor. This approach enables more precise motion prediction, which can lead to improved coding performance and reduced data redundancy.

In other examples, this disclosure describes several alternative or complementary approaches. For example, the hybrid motion vector predictor can be applied at the subblock level, where each subblock derives its motion vector predictor using spatial and temporal motion vectors specific to that subblock. This allows for finer granularity in motion prediction and can be particularly beneficial for blocks with complex motion patterns. Another example involves incorporating chained motion vector prediction, where motion vectors are recursively accumulated from multiple reference blocks to provide additional flexibility in handling intricate motion scenarios. The techniques may also include the use of affine motion models, which derive motion vectors for control points within a block and interpolate them to generate motion vectors for the entire block, enabling the handling of non-linear motion such as rotation or scaling.

The benefits of the techniques of the disclosure include improved compression efficiency through more accurate motion prediction, which reduces residual data and enhances overall coding performance. The hybrid approach leverages the strengths of both spatial and temporal motion vectors, resulting in more precise motion estimation for a wide range of motion patterns. The techniques of this disclosure are scalable and adaptable, allowing for application at various levels of granularity, from entire blocks to subblocks, and can be integrated into existing video coding standards such as HEVC and VVC, as well as into future video coding standards and/or codecs. By supporting advanced methods such as chained motion vector prediction and affine motion models, the techniques of this disclosure are well-suited for handling complex motion scenarios, including rotation, scaling, and perspective changes. These features make the techniques of the disclosure a robust framework for enhancing video coding performance across a variety of applications, including video streaming, broadcasting, and storage.

In one example, this disclosure describes a method of decoding video data, the method comprising receiving a block to be decoded using bi-prediction, determining a spatial motion vector for the block, determining an additional motion vector based on the spatial motion vector, wherein the additional motion vector is a temporal motion vector or a chained motion vector predictor (CMVP), generating a hybrid spatial-temporal motion vector based on the spatial motion vector and the additional motion vector, and decoding the block of video data using bi-prediction and the hybrid spatial-temporal motion vector.

In another example, this disclosure describes an apparatus configured to decode video data, the apparatus comprising a memory, and processing circuitry in communication with the memory, the processing circuitry configured to receive a block to be decoded using bi-prediction, determine a spatial motion vector for the block, determine an additional motion vector based on the spatial motion vector, wherein the additional motion vector is a temporal motion vector or a chained motion vector predictor (CMVP), generate a hybrid spatial-temporal motion vector based on the spatial motion vector and the additional motion vector, and decode the block of video data using bi-prediction and the hybrid spatial-temporal motion vector.

In another example, this disclosure describes a method of encoding video data, the method comprising receiving a block to be encoded using bi-prediction, determining a spatial motion vector for the block, determining an additional motion vector based on the spatial motion vector, wherein the additional motion vector is a temporal motion vector or a chained motion vector predictor (CMVP), generating a hybrid spatial-temporal motion vector based on the spatial motion vector and the additional motion vector, and encoding the block of video data using bi-prediction and the hybrid spatial-temporal motion vector.

In another example, this disclosure describes an apparatus configured to encode video data, the apparatus comprising a memory, and processing circuitry in communication with the memory, the processing circuitry configured to receive a block to be encoded using bi-prediction, determine a spatial motion vector for the block, determine an additional motion vector based on the spatial motion vector, wherein the additional motion vector is a temporal motion vector or a chained motion vector predictor (CMVP), generate a hybrid spatial-temporal motion vector based on the spatial motion vector and the additional motion vector, and encode the block of video data using bi-prediction and the hybrid spatial-temporal motion vector.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2A is a conceptual diagram illustrating spatial motion vector candidates for a merge mode.

FIG. 2B is a conceptual diagram illustrating spatial motion vector candidates for an advanced motion vector prediction (AMVP) mode.

FIG. 3A is a conceptual diagram illustrating temporal motion vector candidates.

FIG. 3B is a conceptual diagram illustrating motion vector scaling.

FIG. 4 is a conceptual diagram illustrating another example of a temporal motion vector prediction candidate and motion vector scaling.

FIG. 5 illustrates an example of template matching on a search area around an initial motion vector.

FIG. 6 illustrates one example of bilateral matching prediction where two motion vectors are proportional based on temporal distances.

FIG. 7 illustrates one example of bilateral matching prediction where two motion vectors are mirrored regardless of temporal distances.

FIG. 8 illustrates an example of a 3×3 square search pattern in the search range [-8,8].

FIG. 9 illustrates an example of decoder-side motion vector refinement.

FIG. 10 illustrates example diamond regions in a search area for subblock-based bilateral matching motion vector refinement.

FIG. 11 illustrates example control point motion vectors for control point motion vector inheritance.

FIG. 12 illustrates example candidate positions for constructed affine merge mode.

FIG. 13 illustrates one example of searching for non-adjacent affine coding units to derive non-refined candidates.

FIG. 14 illustrates one example of subblock motion information used to derive refined candidates.

FIG. 15 is a flowchart illustrating one example of AMVP-merge mode.

FIG. 16 illustrates an example derivation of a chained motion vector prediction (CMVP) candidate.

FIG. 17 illustrates an example operation of referencing source and destination tracing motion vectors in CMVP.

FIG. 18 illustrates an example of CMVP motions with trace depth of one.

FIG. 19 is a block diagram illustrating an example video encoder that may perform the techniques of this disclosure.

FIG. 20 is a block diagram illustrating an example video decoder that may perform the techniques of this disclosure.

FIG. 21 is a flowchart illustrating an example method for encoding a current block in accordance with the techniques of this disclosure.

FIG. 22 is a flowchart illustrating an example method for decoding a current block in accordance with the techniques of this disclosure.

FIG. 23 is a flowchart illustrating another example method for encoding a current block in accordance with the techniques of this disclosure.

FIG. 24 is a flowchart illustrating another example method for decoding a current block in accordance with the techniques of this disclosure.

### DETAILED DESCRIPTION

In video coding, efficient motion vector prediction plays a significant role in achieving high compression efficiency while maintaining video quality. Conventional approaches, such as those employed in standards like High Efficiency Video Coding (HEVC) and Versatile Video Coding (VVC), rely on spatial and temporal motion vector predictors to estimate motion vectors for inter-predicted blocks. Spatial motion vectors are derived from neighboring blocks within the same frame, while temporal motion vectors are derived from co-located blocks in reference frames. However, these methods treat spatial and temporal motion vectors as independent predictors, failing to fully leverage the complementary nature of these two sources of motion information. Current approaches for motion prediction may be sub-optimal for some content, particularly in scenarios involving complex motion patterns or occlusions, where neither spatial nor temporal predictors alone can provide sufficient accuracy.

The present disclosure addresses these limitations by introducing a hybrid spatial-temporal motion vector prediction framework that combines motion vectors from both spatial and temporal domains to generate a more accurate and efficient motion vector predictor. Unlike conventional methods that rely on either spatial or temporal predictors in isolation, the described approach derives a hybrid motion vector predictor by leveraging the strengths of both domains. Specifically, the hybrid predictor uses a spatial motion vector to locate a co-located block in a reference frame and then derives a temporal motion vector from the co-located block. The motion vectors from these two sources are combined to form a bi-directional motion vector predictor, where one list is derived from the spatial domain and the other from the temporal domain. This hybrid approach enhances motion prediction accuracy, leading to improved compression efficiency and reduced residual data.

The techniques of this disclosure include examples that further extend this concept to subblock-level granularity, enabling the derivation of hybrid spatial-temporal motion vector predictors for each subblock within a coding block. This fine-grained approach may be particularly effective in handling blocks with complex or non-uniform motion patterns. Additionally, the techniques of this disclosure include examples that incorporate advanced techniques such as chained motion vector prediction, where motion vectors are recursively accumulated from multiple reference blocks, and hybrid bi-prediction, which combines derived motion vector predictors with chained motion vector predictors. These advancements provide a robust and scalable framework for motion vector prediction, adaptable to various video coding standards and capable of addressing a wide range of motion scenarios.

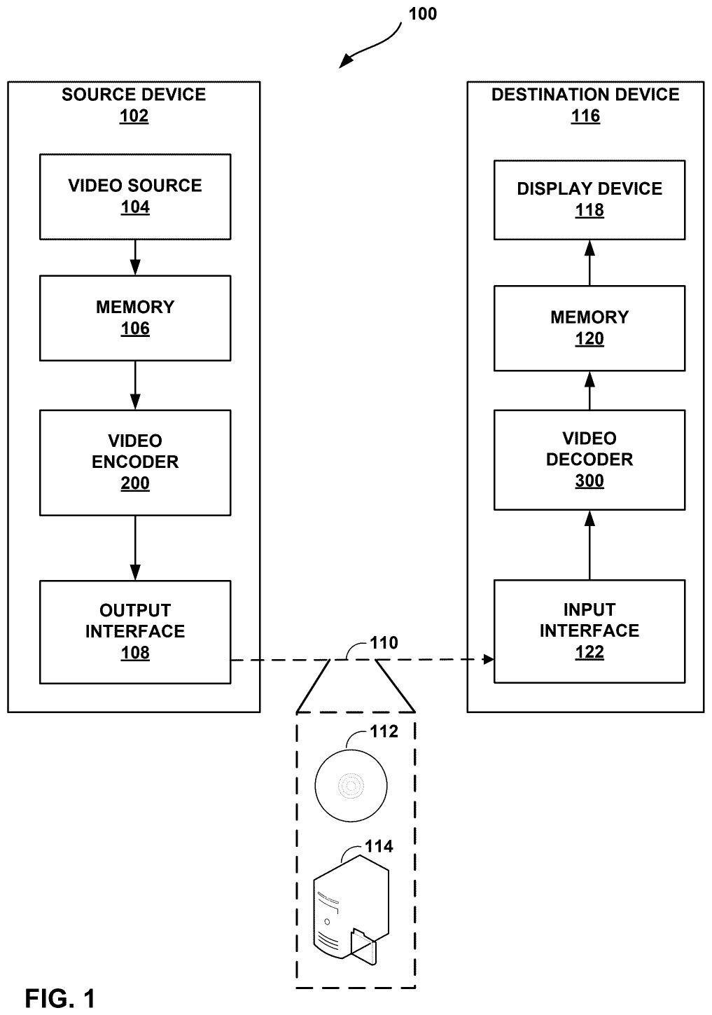

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for motion vector prediction for bi-prediction candidates. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for motion vector prediction for bi-prediction candidates. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (cMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder (e.g., audio codec), and may include appropriate MUX-DEMUX units, or other hardware and/or software, to handle multiplexed streams including both audio and video in a common data stream. Example audio codecs may include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, ILBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Aud.

Video encoder 200 and video decoder 300 each may be implemented as any of a variety of suitable encoder and/or decoder circuitry that includes a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC).

In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use motion vector prediction and bi-prediction candidates.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three subblocks. In some examples, a triple or ternary tree partition divides a block into three subblocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtrec partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

Any of the video encoding or video decoding processes described above may be performed using a neural network (NN). Additionally or alternatively, a neural network may be trained to efficiently compress video data without necessarily separately performing prediction and residual coding. Studies have shown that embedding neural networks into the hybrid video coding framework of video encoder 200 and video decoder 300 can improve compression efficiency. Neural networks may be used for intra prediction and inter prediction to improve the prediction efficiency. NN-based in-loop filtering and/or post-filtering have also performed well in heuristic testing.

For example, video encoder 200 and video decoder may use one or more NN-based filters for existing filters, such as deblocking filters, sample adaptive offset (SAO), and/or adaptive loop filtering (ALF). NN-based filters can also be applied exclusively, where NN-based filters are designed to replace all of the existing filters. Additionally or alternatively, NN-based filters may be designed to supplement, enhance, or replace any or all of the other filters.

In some examples, an NN-based filter may be a convolutional neural network (CNN)-based filter with multiple layers. An NN-based filtering process may take reconstructed samples as inputs, and may add the intermediate outputs back to the inputs to refine the input samples. The NN-based filter may use all color components (e.g., Y, U, and V, or Y, Cb, and Cr) as inputs 172 to exploit cross-component correlations. Different color components may share the same filters (including network structure and model parameters) or each component may have its own specific filters.

The filtering process can also be generalized as follows:

$${R}^{′} ( i , j ) = R ( i , j ) + NN\_filter \_residual \_ouput ( R )$$

Here, R(i, j) represents a reconstructed sample at position (i, j) in the picture, R′(i, j) represents the filtered version of the reconstructed sample, and NN_filter_residaul_output(R) represents the intermediate samples discussed above that are calculated by the NN filter. The model structure and model parameters of NN-based filter(s) can be pre-defined and be stored at video encoder 200 and video decoder 300. The filters can also be signaled in the bitstream.

In some examples, an NN-based filter may include a series of feature extraction layers, followed by an output convolution. The feature extraction layers may include a 3×3 convolution (conv) layer followed by a parametric rectified linear unit (PReLU) layer. The convolutional layer applies a convolution operation to the input data, which involves a filter or kernel processing the input data (e.g., the reconstruction samples) in a sliding window fashion and computing dot products at each position. The convolution operation essentially captures local patterns within the input data. For example, in the context of image processing, these patterns could be edges, textures, or other visual features. The filter or kernel is a small matrix of weights that gets updated during the training process. By sliding this filter across the input data (or feature map from a previous layer) and computing the dot product at each position, the convolutional layer creates a feature map that encodes spatial hierarchies and patterns detected in the input. The output of a convolutional layer is a set of feature maps, each corresponding to one filter, capturing different aspects of the input data. This layer helps the neural network to learn increasingly complex and abstract features as the data passes through deeper layers of the network.

The PReLU layer is an activation function used in neural networks, and is a variant of the ReLU (Rectified Linear Unit) activation function. As described above, the convolution layer outputs feature maps, each corresponding to one filter, representing detected features in the input. Following the convolution layer, the PReLU layer applies the PReLU activation function to each element of the feature maps produced by the convolution layer. For positive values, the PReLU layer acts like a standard ReLU, passing the value through. For negative values, instead of setting them to zero (e.g., as ReLU docs), the PReLU layer allows a small, linear, negative output. This keeps neurons of the NN active and maintains the gradient flow, which can be beneficial for learning in deep networks.

When NN-based filtering is applied in video coding, the whole video signal (pixel data) may be split into multiple processing units (e.g., 2D blocks), and each processing unit can be processed separately or be combined with other information associated with this block of pixels. For example, a processing unit may be a frame, a slice/tile, a CTU, or any pre-defined or signaled shapes and sizes. Typically, NN-based filtering is performed on reconstructed blocks of video data. Here, reconstructed blocks and samples may refer to both decoded blocks produced by video decoder 300, as well blocks reconstructed in a reconstruction loop of video encoder 200.

To further improve the performance of NN-based filtering, different types of input data can be processed jointly to produce the filtered output. Input data may include, but is not limited to, reconstruction pixels/samples, prediction pixels/samples, pixels/samples after the loop filter(s), partitioning structure information, deblocking parameters (e.g., boundary strength (BS)), quantization parameter (QP) values, slice or picture types, or a filters applicability or coding modes map. Input data can be provided at different granularities. Luma reconstruction and prediction samples may be provided at the original resolution, whereas chroma samples may be provided at lower resolution, e.g. for 4:2:0 representation, or can be up-sampled to the Luma resolution to achieve per-pixel representation. Similarly, QP, BS, partitioning, or coding mode information can be provided at lower resolution, including cases with a single value per frame, slice or processing block (e.g. QP). In other examples, QP, BS, partitioning, or coding mode information can be expanded (e.g., replicated) to achieve per-pixel/sample representation.

To further improve the performance of NN-based filtering, multi-mode solutions can be used. For example, for each processing unit, video encoder 200 may select a mode from a set of modes based on rate-distortion optimization and signal the selected mode in the bit-stream. The different modes may include different NN models, different values that may be used as the input information of the NN models, etc. In one example, video encoder 200 and video decoder 300 may use an NN-based filtering solution with multiple modes based on a single NN model by using different QP values as input to the NN model for different modes.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

In accordance with the techniques of this disclosure, as will be explained in more detail below, video encoder 200 and video decoder 300 may derive a motion vector predictor for bi-prediction using both spatial motion vectors and temporal motion vectors. For example, video encoder 200 and video decode 300 may receive a block to be coded using bi-prediction, determine a spatial motion vector for the block, determine an additional motion vector based on the spatial motion vector, wherein the additional motion vector is a temporal motion vector or a chained motion vector predictor (CMVP), generate a hybrid spatial-temporal motion vector based on the spatial motion vector and the additional motion vector, and code the block of video data using bi-prediction and the hybrid spatial-temporal motion vector.

### CU Structure and Motion Vector Prediction in HEVC

In HEVC, the largest coding unit in a slice is called a coding tree block (CTB) or coding tree unit (CTU). A CTB contains a quadtree of nodes of which are coding units. The size of a CTB can range from 16×16 to 64×64 in the HEVC main profile (although technically 8×8 CTB sizes can be supported). A coding unit (CU) could be the same size as a CTB to as small as 8×8. Each coding unit is coded with a coding mode, e.g., inter or intra. When a CU is inter coded, the CU may be further partitioned into 2 or 4 prediction units (PUs) or become just one PU when further partition does not apply. When two PUS are present in one CU, the PUs can be half-size rectangles or two rectangles with ¼ or ¾ the size of the CU. When the CU is inter coded, each PU has one set of motion information, which is derived with a unique inter prediction mode.

### Motion Vector Prediction

In the HEVC standard, there are two inter prediction modes, referred to as merge mode (with skip mode being considered a special case of merge mode) and AMVP mode, respectively, for a PU.

In either AMVP or merge mode, video encoder 200 and video decoder 300 may be configured to maintain a motion vector (MV) candidate list, with the list including multiple motion vector predictors. Video encoder 200 and video decoder 300 may be configured to generate the motion vector(s), as well as reference indices in the merge mode, for the current PU by selecting a candidate from the MV candidate list.

In HEVC, the MV candidate list contains up to 5 candidates for the merge mode and only two candidates for the AMVP mode. A merge candidate may contain a set of motion information, e.g., motion vectors corresponding to both reference picture lists (list 0 and list 1) and the reference indices. If a merge candidate is identified by a merge index, video encoder 200 and video decoder 300 may be configured to determine the reference pictures used for the prediction of the current blocks, as well as the associated motion vectors, based on the selected candidate. For AMVP mode, in contrast, for each potential prediction direction from either list 0 or list 1, a reference index is explicitly signaled, together with an MV predictor (MVP) index to the MV candidate list. In AMVP mode, the predicted motion vectors can be further refined by, for example, receiving a motion vector differences that can be added to the MVP. The candidates for the candidate lists in both modes may be derived similarly from the same spatial and temporal neighboring blocks.

### Spatial Neighboring Candidates

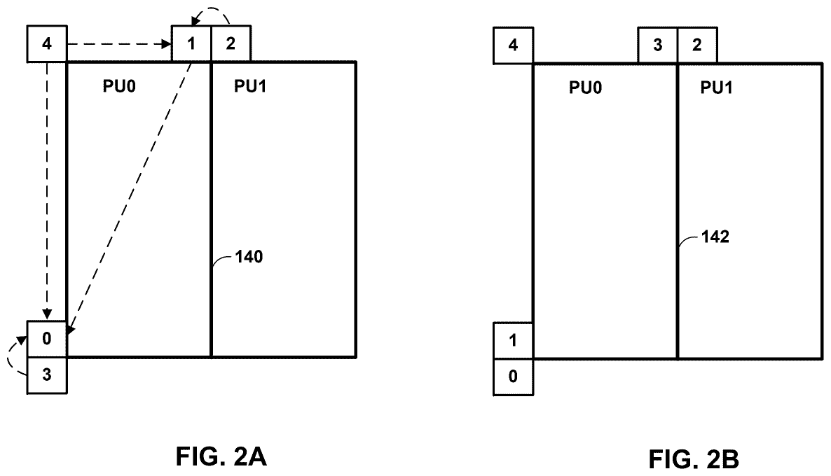

FIG. 2A is a conceptual diagram showing an example of spatial neighboring motion vector candidates for merge mode. Video encoder 200 and video decoder 300 may generate a candidate list by adding the motion information of spatial neighboring candidates to the candidate list. Spatial MV candidates are derived from the neighboring blocks shown in FIGS. 2A and 2B, for a specific PU (PUO), although the processes for generating the candidates from the blocks may differ for merge and AMVP modes. In merge mode, up to five spatial MV candidates can be derived for block 140 (PUO) with the orders shown in FIG. 2A. The order is the following: left (0), above (1), above right (2), below left (3), and above left (4), as shown in FIG. 2A.

FIG. 2B is a conceptual diagram showing an example of spatial neighboring motion vector candidates for AMVP. In AMVP mode, the neighboring blocks of block 142 (PUO) are divided into two groups: a left group including block 0 and 1, and an above group including blocks 2, 3, and 4, as shown in FIG. 2B. For each group, the potential candidate in a neighboring block referring to the same reference picture as that indicated by the signaled reference is prioritized to form a final candidate of the group. It is possible that all neighboring blocks do not contain a motion vector pointing to the same reference picture. Therefore, if such a candidate cannot be found, the first available candidate may be scaled to form the final candidate, allowing the temporal distance differences to be compensated.

### Temporal Motion Vector Prediction in HEVC

Video encoder 200 and video decoder 300 may be configured to add a temporal motion vector predictor (TMVP) candidate, if enabled and available, into the MV candidate list after spatial motion vector candidates are added. The process of motion vector derivation for a TMVP candidate may be the same for both merge and AMVP modes. However, in HEVC, the target reference index for the TMVP candidate in the merge mode may be set to 0.

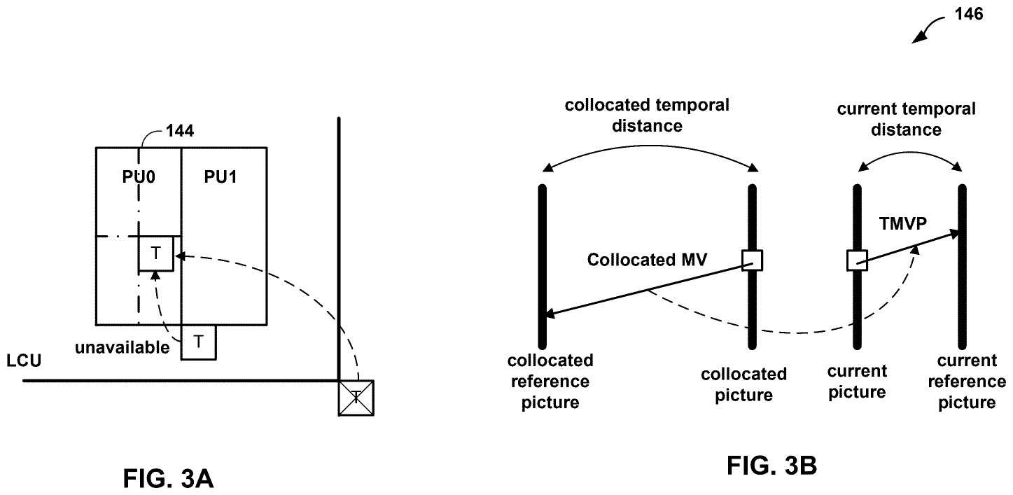

FIG. 3A is a conceptual diagram showing an example of a TMVP candidate for block 144 (PUO). The primary block location for TMVP candidate derivation is the bottom right block outside of the co-located PU, which is shown as block “T” in FIG. 3A, to compensate the bias to the above and left blocks used to generate spatial neighboring candidates. However, if that block is located outside of the current CTB row or motion information is not available, the block is substituted with a center block of the PU.

Video decoder 300 may derive a motion vector for the TMVP candidate from the co-located PU of the co-located picture, indicated at a slice level. The motion vector for the co-located PU is called the co-located MV. A block in a reference picture may, for example, be considered to be co-located to a block in a current picture if the block in the reference picture and the current block each include at least one pixel corresponding to a same relative position in the reference picture and the current picture.

FIG. 3B is a conceptual timing diagram showing an example of motion vector scaling process 146. Similar to temporal direct mode in AVC, to derive the TMVP candidate motion vector, video decoder 300 may scale the co-located MV to compensate for the temporal distance differences, as shown in FIG. 3B.

### Temporal Motion Information Derivation in the Enhanced Compression Model (ECM)

In VVC, a temporal motion vector predictor for the AMVP and merge mode is derived by fetching the motion information from the center or the bottom-right of the co-located block in a signaled co-located picture. Similarly, for the subblock-based temporal motion vector prediction (SbTMVP) mode, the motion information from the left neighboring position is used as a motion shift, which is then employed to obtain TMVPs at the sub-CU level.

In ECM, to further improve the coding efficiency of TMVP, two aspects are modified. Firstly, two co-located pictures are utilized, which are the two reference frames with the least picture order count (POC) distance relative to the to-be-coded frame. Secondly, the motion shift to locate the TMVP is adaptively determined from multiple locations according to template costs. More specifically, two motion shift candidate lists are constructed, respectively, for the two co-located frames. The motion shifts with the minimum template matching cost are used to derive SbTMVP or TMVP candidates. In one example, at most, four SbTMVP candidates are included in the subblock-based merge list. The SbTMVP candidate with the least template matching cost derived from the first co-located frame is placed in the first entry without reordering, while other SbTMVP candidates are sorted together with affine candidates. In addition, the prediction direction of each subblock template is determined based on the center subblock.

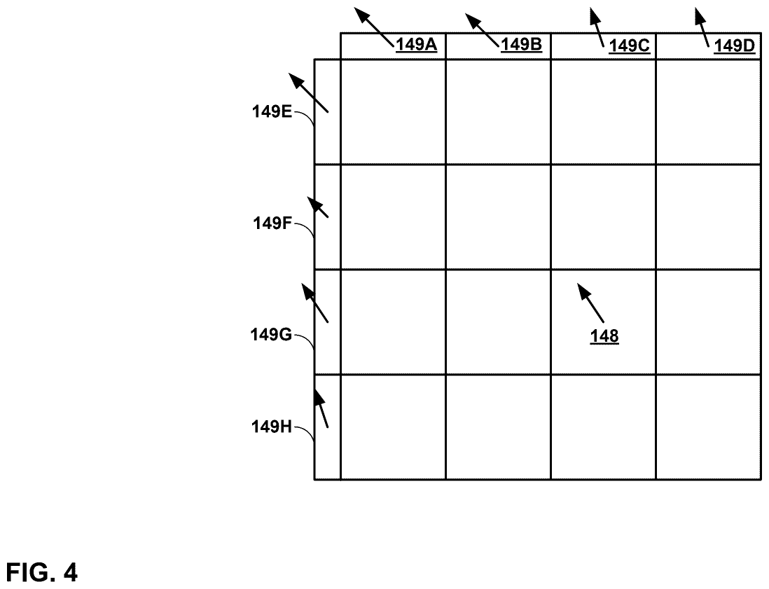

FIG. 4 is a conceptual diagram illustrating example TMVP candidate and MV scaling. As illustrated in FIG. 4, if the center subblock 148 is uni-predicted, then all the subblock templates 149A-149H are uni-predicted, and vice versa. If the motion vector of corresponding adjacent subblock at the determined reference list is not available for a subblock template, a zero MV is used for that subblock template.

### Other Aspects of Motion Prediction in HEVC

With motion vector scaling, it is generally assumed that the value of motion vectors is proportional to the distance of pictures in the presentation time. A motion vector associates two pictures: the reference picture, and the picture containing the motion vector (namely the containing picture). When a motion vector is utilized to predict the other motion vector, the distance of the containing picture and the reference picture is calculated based on the Picture Order Count (POC) values.

For a motion vector being predicted, the associated containing picture and reference picture may be different. Therefore, a new distance based on POC may be calculated, and the motion vector may be scaled based on the two POC distances. For a spatial neighboring candidate, the containing pictures for the two motion vectors are the same, while the reference pictures are different. In HEVC, motion vector scaling applies to both TMVP and AMVP for spatial and temporal neighboring candidates.

Video encoder 200 and video decoder 300 may be configured to perform artificial motion vector candidate generation. If a motion vector candidate list is not complete (e.g., less than some predetermined number of candidates), artificial motion vector candidates are generated and inserted at the end of the list until the list has the designated number of candidates.

In merge mode, there are two types of artificial MV candidates: combined candidate derived only for B-slices and zero motion vector candidates used for AMVP if the first type does not provide enough artificial candidates.

For each pair of candidates that are already in the candidate list and have necessary motion information, bi-directional combined motion vector candidates are derived by a combination of the motion vector of the first candidate referring to a picture in the list 0 and the motion vector of a second candidate referring to a picture in the list 1.

Video encoder 200 and video decoder 300 may be configured to perform a pruning process for candidate insertion. Candidates from different blocks may happen to be the same, which decreases the efficiency of a merge/AMVP candidate list. A pruning process is applied to solve this problem. The pruning process compares one candidate against the others in the current candidate list to avoid inserting identical candidate in certain extent. To reduce the complexity, only limited numbers of pruning processes are applied instead of comparing each potential candidate with all the other existing candidates.

### Template Matching Prediction

Video encoder 200 and video decoder 300 may be configured to perform template matching (TM) prediction. TM prediction is a special merge mode based on Frame-Rate Up Conversion (FRUC) techniques. In TM prediction, motion information for a block is not signaled but derived at the decoder side. TM prediction may be applied to both AMVP mode and regular merge mode. In AMVP mode, MVP candidate selection is determined based on template matching identifying candidate that results in the minimal difference between a current block template and a reference block template. In regular merge mode, a TM mode flag may be signaled to indicate the use of TM and then TM may be applied to the merge candidate indicated by merge index for MV refinement.

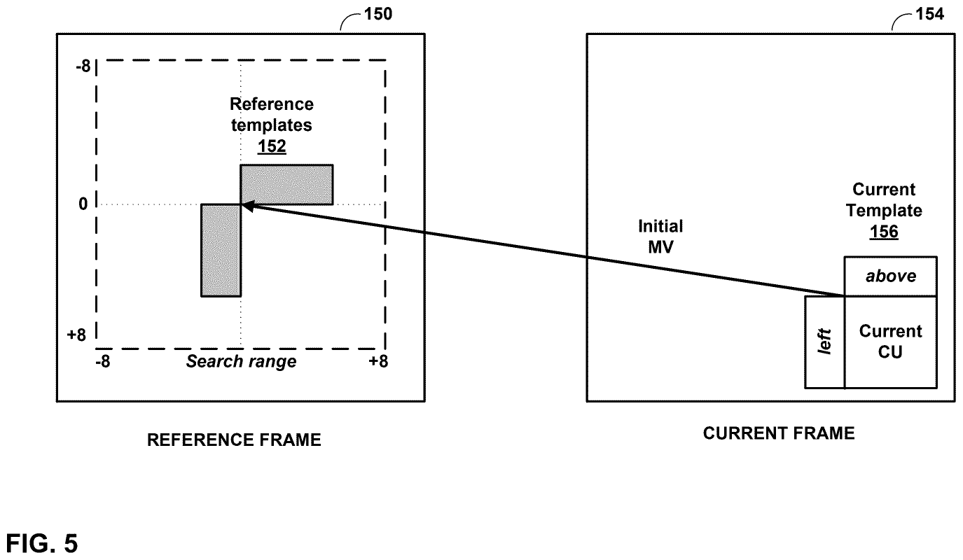

FIG. 5 shows an example template matching process being performed on a search area around an initial MV. As shown in FIG. 5, video encoder 200 and video decoder 300 may be configured to use template matching to derive motion information of the current CU by finding the closest match between current template 156 (top and/or left neighboring blocks of the current CU) in current picture 154 and a template within reference templates 152 for a reference block (same size to the template) in reference picture 150. With an AMVP candidate selected based on initial matching error, video encoder 200 and video decoder 300 may refine the MVP with template matching. With a merge candidate indicated by a signaled merge index, the merged MVs corresponding to L0 and L1 may be refined independently by template matching. The less accurate of the merged MV may then be further refined based on the more accurate merged MV.

Video encoder 200 and video decoder 300 may be configured to implement a cost function. When a motion vector points to a fractional sample position, motion compensated interpolation is needed. To reduce complexity, bi-linear interpolation instead of regular 8-tap DCT-IF interpolation may be used for both template matching to generate templates in reference pictures. An example matching cost C for template matching may be calculated as follows:

$$C = SAD + w \cdot ( \vert {MV}_{x} - {MV}_{x}^{s} \vert + \vert {MV}_{y} - {MV}_{y}^{s} \vert ) ,$$

where w is a weighting factor which is empirically set to 4, MV and MV^{s} indicate the currently testing MV and the initial MV (e.g., an MVP candidate in AMVP mode or a merged MV in merge mode), respectively. SAD is used as the matching cost of template matching.

When TM is used, video encoder 200 and video decoder 300 may be configured to refine the motion vector (e.g., the initial MV) using luma samples only. The motion vector determined based on the refinement, however, may be used for both luma and chroma for MC inter prediction. After a MV is determined, final motion compensation may be performed using an 8-tap interpolation filter for luma and a 4-tap interpolation filter for chroma.

Video encoder 200 and video decoder 300 may be configured to implement a search process. MV refinement may include a pattern-based MV search process with the criterion of template matching cost and utilizing a hierarchical structure. Two search patterns are supported-a diamond search and a cross search for MV refinement. The hierarchical structure specifies an iterative process to refine a MV, starting at a coarse MVD precision (e.g., quarter-pel) and ending at a finer precision (e.g., ⅛-pel). For example, a quarter-pel MV precision implies that a template matching process is performed on a search area around an initial MV to identify a refined MV where a step size of the search uses a quarter of a luma-sample distance (or resolution) as the MVD precision (between the initial MV and the refined MV). The MV is directly searched at a quarter luma sample MVD precision with a diamond pattern, followed by quarter luma sample MVD precision with a cross pattern, and then this is followed by one-eighth luma sample MVD refinement with cross pattern. The search range of MV refinement is set equal to (−8, +8) luma samples around the initial MV. When the current block is of bi-prediction, both MVs are refined independently, and then the best of which (in terms of matching cost) is set as a prior to further refine the other MV with bi-prediction with CU-level weight (BCW) weight values.

### Bilateral Matching Prediction

Video encoder 200 and video decoder 300 may be configured to perform bilateral matching prediction. Bilateral matching (BM) prediction, also referred to as bilateral merge, is another merge mode based on FRUC techniques. When applying BM prediction mode to a block, video encoder 200 and video decoder 300 may derive two initial motion vectors MV0 and MV1 using a signaled merge candidate index to select the merge candidate in a constructed merge list. When implementing bilateral matching, video encoder 200 and video decoder 300 search around the MV0 and MV1 and derive the final MV0′ and MV1′ based on a minimum bilateral matching cost.

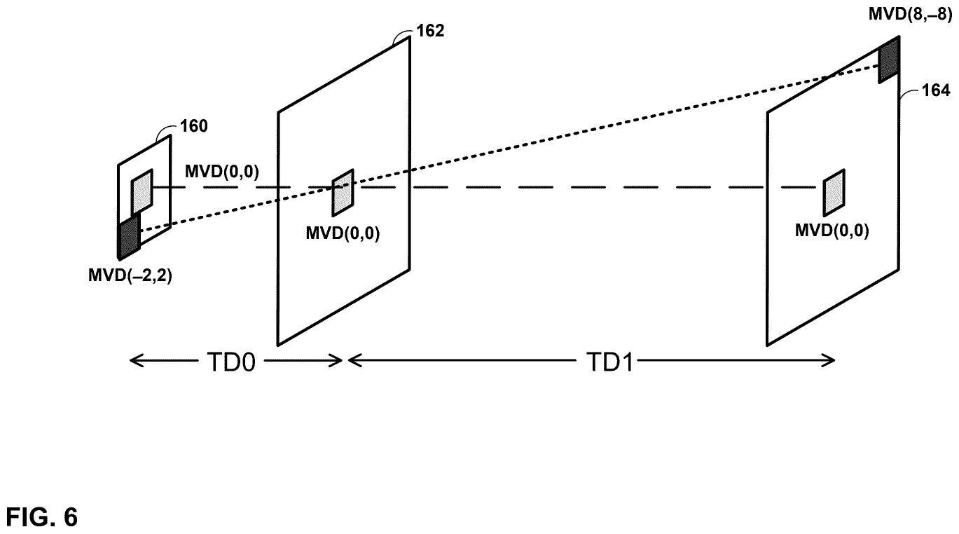

The motion vector difference MVD0 (denoted by MV0′−MV0) and MVD1 (denoted by MV1′−MV1) pointing to the two reference blocks may be proportional to the temporal distances (TD), e.g. TD0 and TD1, between the current picture and the two reference pictures. FIG. 6 shows an example of MVD0 and MVD1 where the distance (TD1) between current picture 162 and reference picture 164 is 4-times the distance (TD0) between current picture 162 and reference picture 160. FIG. 6 shows an example of MVD0 and MVD1 being proportional based on the temporal distances.

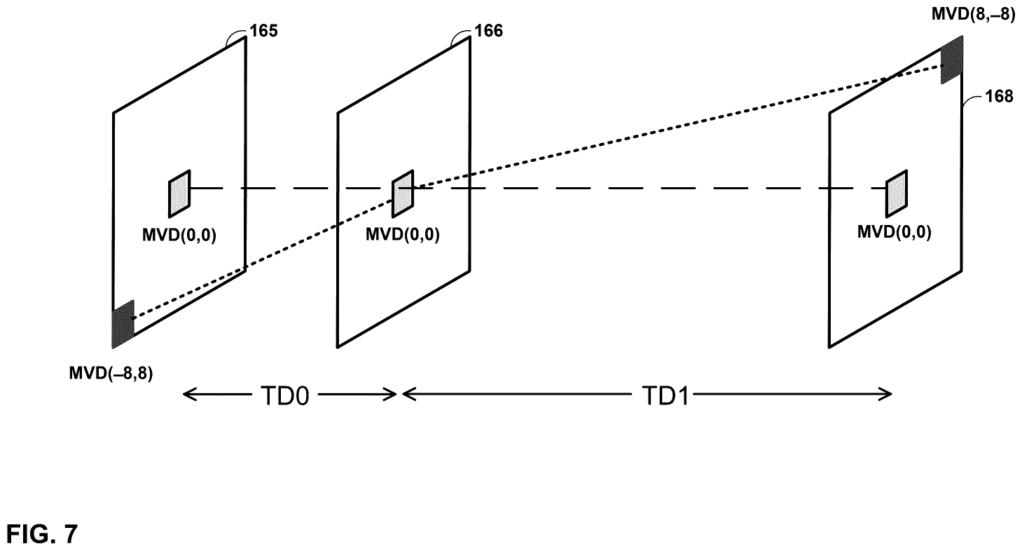

However, there is an optional design where MVD0 and MVD1 are mirrored regardless of the temporal distances TD0 and TD1. FIG. 7 shows an example of MVD0 and MVD1 being mirrored regardless of the temporal distance (TD1) between current picture 166 and reference picture 168 and the temporal distance (TD0) between current picture 166 and reference picture 165. FIG. 6 shows an example of mirrored MVD0 and MVD1, where TD1 is 4-times of TD0.

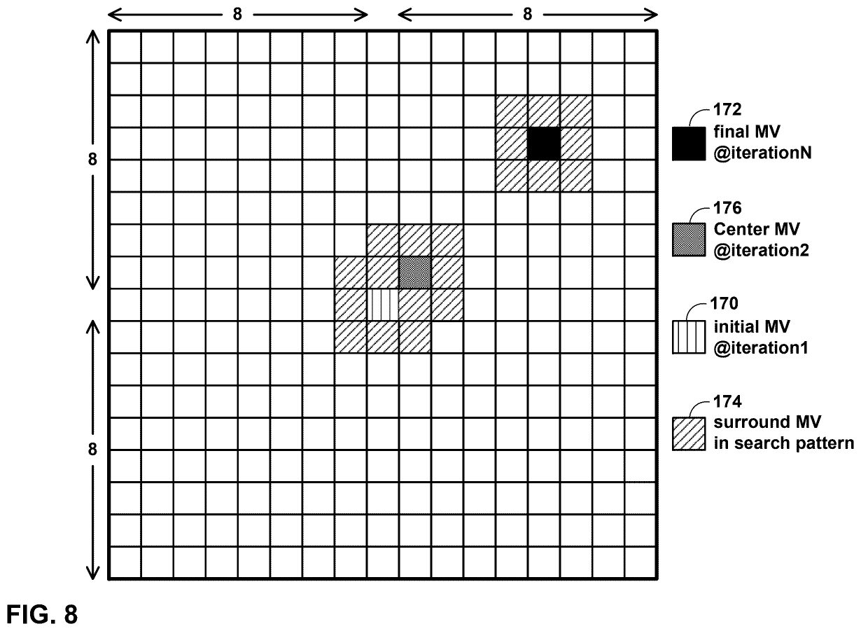

FIG. 8 is a conceptual diagram illustrating an example of the 3×3 square search pattern in the search range [−8, 8]. FIG. 8 shows an example of 3×3 square search patterns in the search range [−8, 8] for implementing bilateral matching. When implementing bilateral matching, video encoder 200 and video decoder 300 may be configured to perform a local search around the initial MV0 and MV1 to derive the final MV0′ and MV1′. In the example of FIG. 8, the initial MV points to sample 170, and the final MV points to sample 172. The local search applies a 3×3 square search pattern to loop through the search range [−8, 8]. Samples 174 represent examples of samples in the search range around samples 170, 176, and sample 176. Sample 176 represents an example of a sample corresponding to a MV determined during an intermediate iteration of the search process. In each search iteration, the bilateral matching cost of the eight surrounding MVs in the search pattern are calculated and compared to the bilateral matching cost of center MV. The MV which has minimum bilateral matching cost becomes the new center MV in the next search iteration. The local search is terminated when the current center MV has a minimum cost within the 3×3 square search pattern or the local search reaches the pre-defined maximum search iteration.

### Decoder-Side Motion Vector Refinement

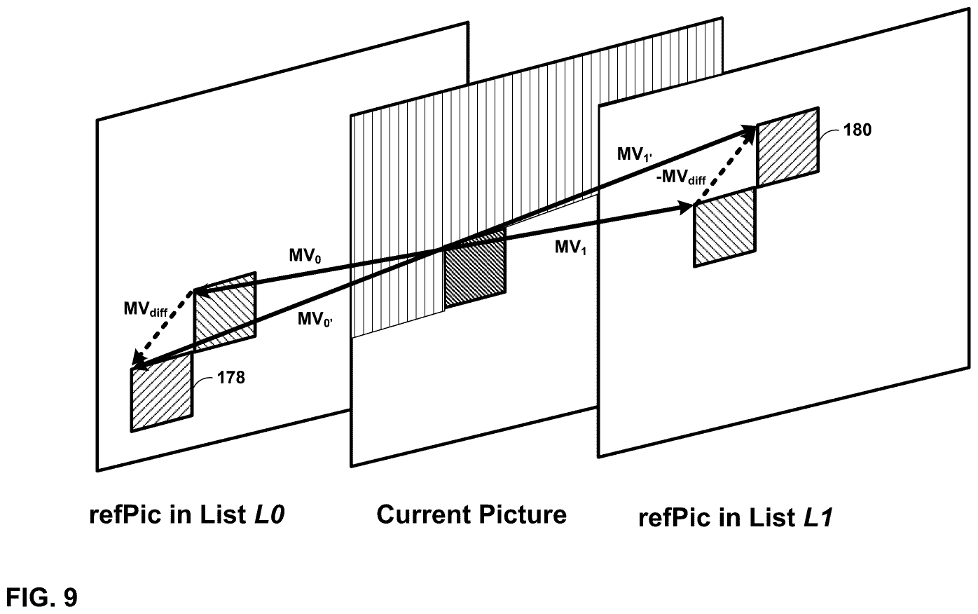

To increase the accuracy of the MVs of the merge mode, a decoder side motion vector refinement (DMVR) may be applied in VVC. In bi-prediction operation, a refined MV is searched around the initial MVs in the reference picture list L0 and reference picture list L1. The DMVR method calculates the distortion between the two candidate blocks in the reference picture list L0 and list L1. As illustrated in FIG. 9, the SAD between block 178 and block 180, based on each MV candidate around the initial MV, is calculated. The MV candidate with the lowest SAD becomes the refined MV and is used to generate the bi-predicted signal.

The refined MV derived by DMVR process is used to generate the inter prediction samples and also used in temporal motion vector prediction for future pictures coding. While the original MV is used in deblocking process and also used in spatial motion vector prediction for future CU coding.

DMVR is a subblock based merge mode with a pre-defined maximum processing unit of 16×16 luma samples. When the width and/or height of a CU are larger than 16 luma samples, the CU may be further split into subblocks with width and/or height equal to 16 luma samples.

### Searching Scheme

In DVMR, the search points are surrounding the initial MV and the MV offset obey the MV difference mirroring rule. In other words, any points that are checked by DMVR, denoted by candidate MV pair (MV0, MV1) obey the following two equations:

$$\begin{matrix}MV {0}^{′} = MV 0 + MV\_offset \\ MV {1}^{′} = MV 1 - MV\_offset ,\end{matrix}$$

where MV_offset represents the refinement offset between the initial MV and the refined MV in one of the reference pictures. The refinement search range is two integer luma samples from the initial MV. The searching includes the integer sample offset search stage and fractional sample refinement stage.

A 25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To reduce the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form:

$$E ( x , y ) = {A ( x - {x}_{min} )}^{2} + {B ( y - {y}_{min} )}^{2} + C ,$$

where (xₘᵢₙ,yₘᵢₙ) corresponds to the fractional position with the least cost and C corresponds to the minimum cost value. By solving the above equations by using the cost value of the five search points, the (xₘᵢₙ,yₘᵢₙ) is computed as:

$$\begin{matrix}{x}_{min} = ( E ( - 1 , 0 ) - E ( 1 , 0 ) ) / ( 2 ( E ( - 1 , 0 ) + E ( 1 , 0 ) - 2 E ( 0 , 0 ) ) ) \\ {y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) )\end{matrix}$$

The value of xₘᵢₙ and yₘᵢₙ are automatically constrained to be between −8 and 8 since all cost values are positive and the smallest value is E(0,0). This corresponds to half-pel offset with 1/16th-pel MV accuracy in VVC. The computed fractional (xₘᵢₙ,yₘᵢₙ) are added to the integer distance refinement MV to get the sub-pixel accurate refinement delta MV.

### Bilinear-Interpolation and Sample Padding

In VVC, the resolution of the MVs is 1/16 luma samples. The samples at the fractional position are interpolated using an 8-tap interpolation filter. In DMVR, the search points are surrounding the initial fractional-pel MV with integer sample offset. Therefore, the samples of those fractional position are interpolated for the DMVR search process. To reduce the calculation complexity, the bi-linear interpolation filter is used to generate the fractional samples for the searching process in DMVR. Another effect is that by using bi-linear filter is that with 2-sample search range, the DVMR process does not access more reference samples compared to the normal motion compensation process. After the refined MV is attained with DMVR search process, the normal 8-tap interpolation filter is applied to generate the final prediction. In order to not access more reference samples to normal MC process, the samples, which are not needed for the interpolation process based on the original MV but are needed for the interpolation process based on the refined MV, may be padded from those available samples.

### Enabling Condition

DMVR is enabled if the following conditions are all satisfied.
CU level merge mode with bi-prediction MV
One reference picture is in the past and another reference picture is in the future with respect to the current picture
The distances (i.e., POC difference) from both reference pictures to the current picture are same
CU has more than 64 luma samples
Both CU height and CU width are larger than or equal to 8 luma samples
BCW weight index indicates equal weight
Weighted Prediction (WP) is not enabled for the current block
Combined Intra Inter Prediction (CIIP) mode is not used for the current block

### Multi-Pass Decoder-Side Motion Vector Refinement in ECM

In some examples, a multi-pass decoder-side motion vector refinement is applied. In the first pass, bilateral matching (BM) is applied to the coding block. In the second pass, BM is applied to each 16×16 subblock within the coding block. In the third pass, an MV in each 8×8 subblock is refined by applying bi-directional optical flow (BDOF). The refined MVs are stored for both spatial and temporal motion vector prediction.

### First Pass—Block-Based Bilateral Matching MV Refinement

In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

BM performs local search to derive integer sample precision intDeltaMV. The local search applies a 3×3 square search pattern to loop through the search range [−sHor, sHor] in horizontal direction and [−sVer, sVer] in vertical direction, wherein the values of sHor and s Ver are determined by the block dimension, and the maximum value of sHor and sVer is 8.

The bilateral matching cost is calculated as: bilCost=mvDistanceCost+sadCost. When the block size cbW*cbH is greater than 64, MRSAD cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continue to search for the minimum cost, until it reaches the end of the search range.

The existing fractional sample refinement is further applied to derive the final deltaMV. The refined MVs after the first pass is then derived as:

$$\begin{matrix}MV 0 \_pass 1 = MV 0 + delta MV \\ MV 1 \_pass 1 = MV 1 - delta MV\end{matrix}$$

### Second Pass—Subblock-Based Bilateral Matching MV Refinement

In the second pass, a refined MV is derived by applying BM to a 16×16 grid subblock. For each subblock, a refined MV is searched around the two MVs (MV0_pass1 and MV1_pass1), obtained on the first pass, in the reference picture list L0 and L1. The refined MVs (MV0_pass2(sbIdx2) and MV1_pass2(sbIdx2)) are derived based on the minimum bilateral matching cost between the two reference subblocks in L0 and L1.

For each subblock, BM performs full search to derive integer sample precision intDeltaMV. The full search has a search range [−sHor, sHor] in horizontal direction and [−sVer, sVer] in vertical direction, wherein, the values of sHor and sVer are determined by the block dimension, and the maximum value of sHor and sVer is 8.

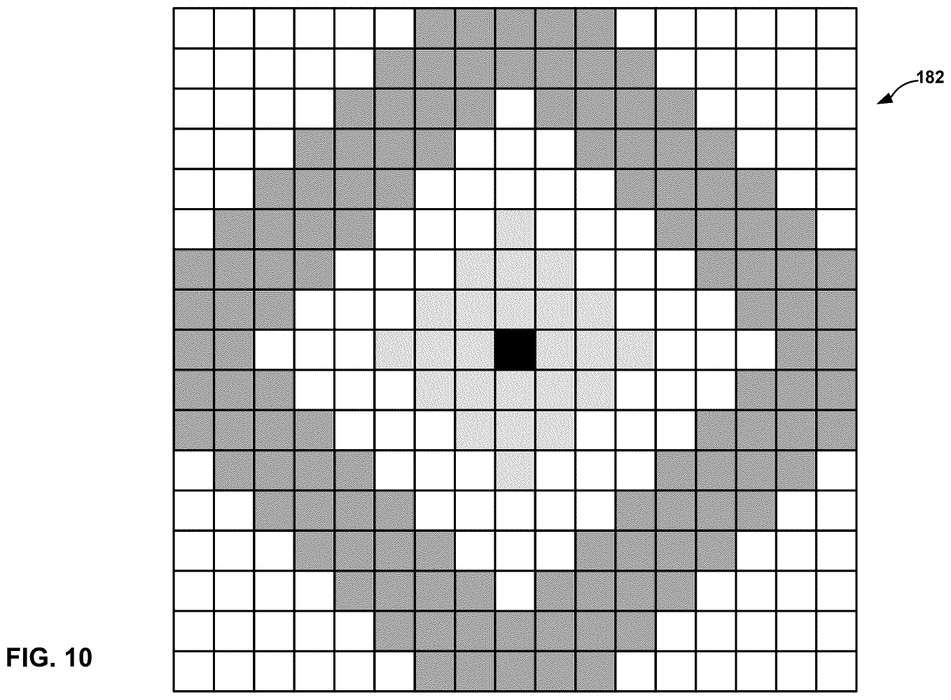

FIG. 10 is a conceptual diagram illustrating example diamond regions in a search area. The bilateral matching cost is calculated by applying a cost factor to the SATD cost between two reference subblocks, as: bilCost=satdCost*costFactor. The search area (2*sHor+1)*(2*sVer+1) is divided up to 5 diamond shape search regions in search area 182 shown in FIG. 10. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined.

The existing VVC DMVR fractional sample refinement is further applied to derive the final deltaMV (sbIdx2). The refined MVs at second pass is then derived as:

$$\begin{matrix}MV0\_pass2 ( s b I d x 2 ) = MV0\_pass 1 + deltaMV ( s b I d x 2 ) \\ MV1\_pass2 ( sb I d x 2 ) = MV1\_pass 1 - deltaMV ( s b I d x 2 )\end{matrix}$$

### Third Pass—Subblock-Based Bi-Directional Optical Flow MV Refinement

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv(Vx, Vy) is rounded to 1/16 sample precision and clipped between −32 and 32.

The refined MVs (MV0_pass3(sbIdx3) and MV1_pass3(sbIdx3)) at third pass are derived as:

$$\begin{matrix}MV0\_pass3 ( sb I d x 3 ) = MV0\_pass2 ( s b I d x 2 ) + bioMv \\ MV1\_pass3 ( sbI d x 3 ) = MV0\_pass2 ( s b I d x2 ) - bioMv\end{matrix}$$

### Affine Motion Model

An affine motion model can be described as follows:

$$\{ \begin{matrix}{v}_{x} = a x + b y + e \\ {v}_{y} = c x + d y + f\end{matrix} ,$$

wherein (vₓ, v_{y}) is the motion vector at the coordinate (x, y), and a, b, c, d, e, and f are the six affine parameters. This affine motion model is referred to as a 6-parameters affine motion model. In a typical video coder, a picture is partitioned into blocks for block-based coding. The affine motion model for a block can also be described by the 3 motion vectors (MVs) \vec{v}₀=(v₀ₓ, v_{0y}), \vec{v}₁=(v₁ₓ, v_{1y}), and \vec{v}₂=(v₂ₓ, v_{2y}) at 3 different locations that are not in the same line. The 3 locations are usually referred to as control-points, the 3 motion vectors are referred to as control-point motion vectors (CPMVs). In the case when the 3 control-points are at the 3 corners of the block, the affine motion can be described as:

$$\{ \begin{matrix}{v}_{x} = \frac{( {v}_{1 x} - {v}_{0 x} )}{b l k W} x + \frac{( {v}_{2 x} - {v}_{0 x} )}{b l k H} y + {v}_{0 x} \\ {v}_{y} = \frac{( {v}_{1 y} - {v}_{0 y} )}{b l k W} x + \frac{( {v}_{2 y} - {v}_{0 y} )}{b l k H} y + {v}_{0 y}\end{matrix} ,$$

wherein blkW and blkH are the width and height of the block.

In affine mode, different motion vectors can be derived for each pixel in the block according to the associate affine motion model. Therefore, motion compensation can be performed pixel-by-pixel. However, to reduce the complexity, subblock based motion compensation is usually adopted, wherein the block is partitioned into multiple subblocks (that have smaller block size) and each subblock is associate with one motion vector for block-based motion compensation. The motion vector for each subblock is derived using the representative coordinate of the subblock. Typically, the center position is used. In one example, the block is partitioned into non-overlapping subblocks. The block width is blkW, block height is blkH, the subblock width is sbW and subblock height is sbH, then there are blkH/sbH rows of subblocks and blkW/sbW subblocks in each row. For a six-parameter affine motion model, the motion vector for the subblock (referred to as subblock MV) at iₜₕ row (0<=i<blkW/sbW) and jₜₕ (0<=j<blkH/sbH) column is derived as follows:

$$\{ \begin{matrix}{v}_{x} = \frac{( {v}_{1 x} - {v}_{0 x} )}{b l k W} ( j * sbW + \frac{s b W}{2} ) + \frac{( {v}_{2 x} - {v}_{0 x} )}{b l k H} ( i * s b H + \frac{s b H}{2} ) + {v}_{0 x} \\ {v}_{y} = \frac{( {v}_{1 y} - {v}_{0 y} )}{b l k W} ( j * sbW + \frac{s b W}{2} ) + \frac{( {v}_{2 y} - {v}_{0 y} )}{b l k H} ( i * s b H + \frac{s b H}{2} ) + {v}_{0 y}\end{matrix}$$

The subblock MVs are rounded to the predefined precision and stored in the motion buffer for motion compensation and motion vector prediction.

A simplified 4-parameters affine model (for zoom and rotational motion) is described as follows:

$$\{ \begin{matrix}{v}_{x} = ax - by + e \\ {v}_{y} = bx + ay + f\end{matrix}$$

Similarly, the 4-parameters affine model for a block can be described by 2 CPMVs \vec{v}₀=(v₀ₓ, v_{0y}) and \vec{v}₁=(v₁ₓ, v_{1y}) at the 2 corners (typically top-left and top-right) of the block. The motion field is then described as follows:

$$\{ \begin{matrix}{v}_{x} = \frac{( {v}_{1 x} - {v}_{0 x} )}{b l k W} x - \frac{( {v}_{1 y} - {v}_{0 y} )}{b l k W} y + {v}_{0 x} \\ {v}_{y} = \frac{( {v}_{1 y} - {v}_{0 y} )}{b l k W} x + \frac{( {v}_{1 x} - {v}_{0 x} )}{b l k W} y + {v}_{0 y}\end{matrix}$$

The subblock MV at iₜₕ row and jₜₕ column is derived as follows:

$$\{ \begin{matrix}{v}_{x} = \frac{( {v}_{1 x} - {v}_{0 x} )}{b l k W} ( j * s b W + \frac{s b W}{2} ) - \frac{( {v}_{1 y} - {v}_{0 y} )}{b l k W} ( i * s b H + \frac{s b H}{2} ) + {v}_{0 x} \\ {v}_{y} = \frac{( {v}_{1 y} - {v}_{0 y} )}{b l k W} ( j * sbW + \frac{s b W}{2} ) + \frac{( {v}_{1 x} - {v}_{0 x} )}{b l k W} ( i * s b H + \frac{s b H}{2} ) + {v}_{0 y}\end{matrix}$$

### Prediction Refinement for Affine Mode

After the subblock based affine motion compensation is performed, the prediction signal can be refined by adding an offset derived based on the pixel-wise motion and the gradient of the prediction signal. The offset at location (m, n) can be calculated as:

$$Δ I ( m , n ) = {g}_{x} ( m , n ) * Δ {v}_{x} ( m , n ) + {g}_{y} ( m , n ) * Δ {v}_{y} ( m , n ) ,$$

wherein gₓ(m, n) is the horizontal gradient and g_{y}(m, n) is the vertical gradient of the prediction signal, respectively. Δvₓ(m, n) and Δv_{y}(m, n) are the differences in x and y components between the motion vector calculated at location pixel location (m, n) and the subblock MV. Let the coordinate of the top-left sample of the subblock be (0,0), the center of the subblock is

$$( \frac{s b W}{2} , \frac{sbH}{2} ) .$$

Given the affine motion parameters a, b, c, and d, Δvₓ(m, n) and Δv_{y}(m, n) can be derived as:

$$\begin{matrix}Δ {v}_{x} ( m , n ) = a * ( m - \frac{s b W}{2} ) + b * ( n - \frac{s b H}{2} ) \\ Δ {v}_{y} ( m , n ) = c * ( m - \frac{s b W}{2} ) + d * ( n - \frac{s b H}{2} )\end{matrix}$$

In the control-points based affine motion model, the affine motion parameters a, b, c, and d are calculated from the CPMVs as:

$$\begin{matrix}a = \frac{( {v}_{1 x} - {v}_{0 x} )}{b l k W} \\ b = \frac{( {v}_{2 x} - {v}_{0 x} )}{b l k H} \\ c = \frac{( {v}_{1 y} - {v}_{0 y} )}{b l k W} \\ d = \frac{( {v}_{2 y} - {v}_{0 y} )}{b l k H}\end{matrix}$$

### Affine Merge Mode

In affine merge mode of VVC, the CPMVs of the current CU are generated based on the motion information of the spatial neighboring CUs. There can be up to five candidates and an index is signaled to indicate the one to be used for the current CU. The following three types of candidates are used to form the affine merge candidate list:
Inherited affine merge candidates that extrapolated from the CPMVs of the neighbor CUs
Constructed affine merge candidates that are derived using the translational MVs of the neighbor CUs
Zero MVs

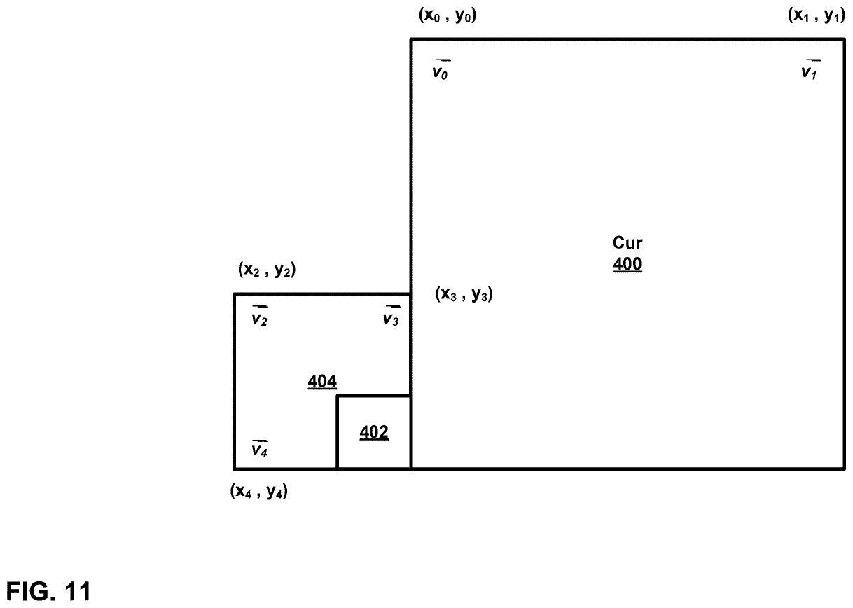

FIG. 11 is a conceptual diagram illustrating an example of control point motion vector inheritance. In VVC, when a neighboring affine CU is identified, its control point motion vectors are used to derived the inherited affine merge candidate in the affine merge list of the current CU. As shown in FIG. 11, if the neighbor left bottom block 402 is coded in affine mode, the motion vectors v₂, v₃ and v₄ of the top left corner, above right corner and left bottom corner of the CU 404 which contains block 402 are attained. When block 402 is coded with 4-parameter affine model, the two CPMVs of current CU 400 are calculated according to v₂, and v₃. In case that block 402 is coded with 6-parameter affine model, the three CPMVs of current CU 400 are calculated according to v₂, v₃ and v₄.

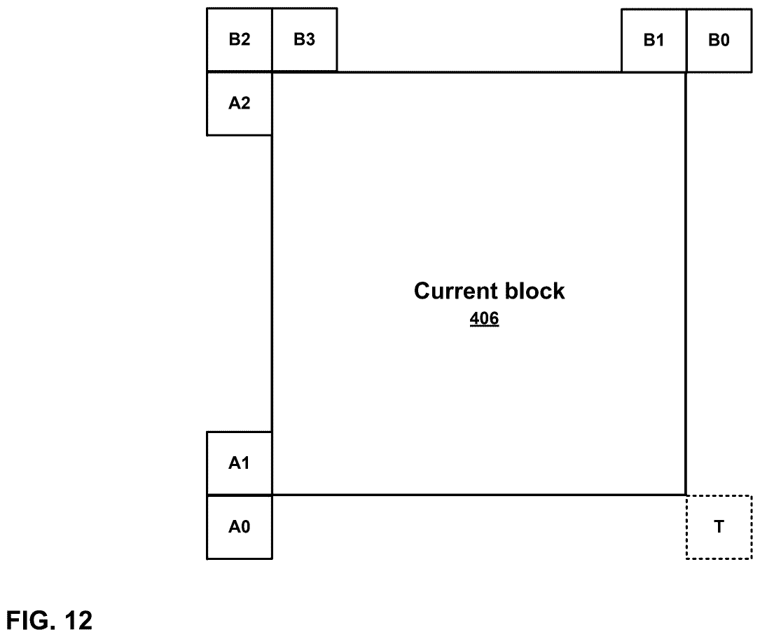

Constructed affine candidate means the candidate is constructed by combining the neighbor translational motion information of each control point. FIG. 12 is a conceptual diagram illustrating example locations of candidate positions for constructed affine merge mode. The motion information for the control points is derived from the specified spatial neighbors and temporal neighbor of a current block 406 shown in FIG. 12. CPMVk (k=1, 2, 3, 4) represents the k-th control point. For CPMV1, the B2->B3->A2 blocks are checked and the MV of the first available block is used. For CPMV2, the B1->B0 blocks are checked and for CPMV3, the A1->A0 blocks are checked. TMVP is used as CPMV4 if TMVP is available. The following combinations of control point MVs are used to construct affine merge candidates in a given order with at most 6 different candidates: {CPMV1, CPMV2, CPMV3}, {CPMV1, CPMV2, CPMV4}, {CPMV1, CPMV3, CPMV4}, {CPMV2, CPMV3, CPMV4}, {CPMV1, CPMV2}, {CPMV1, CPMV3}. The combination of 3 CPMVs constructs a 6-parameter affine merge candidate and the combination of 2 CPMVs constructs a 4-parameter affine merge candidate. To avoid a motion scaling process, if the reference indices of control points are different, the related combination of control point MVs may be discarded.

Video encoder 200 or video decoder 300 may also add zero MVs to the subblock merge candidate list, after inherited affine merge candidates and constructed affine merge candidate are checked if the list is not full. Zero MVs are inserted until the list is full.

### Affine AMVP Mode

In VVC, affine flag in coding unit (CU) level is signaled in the bitstream to indicate whether affine AMVP mode is used and then another flag is signaled to indicate whether 4-parameter affine or 6-parameter affine. In affine AMVP mode, the motion vector difference (MVD) between the CPMVs of current CU and their predictors CPMVPs is signaled in the bitstream together with the index of predictors and the index of the selected reference picture for each of the applicable prediction direction. In case of 4-parameter affine, two MVDs are signaled per applicable prediction direction. In case of 6-parameter affine, three MVDs are signaled per applicable prediction direction. When coding the 2^{nd} and 3^{rd} (in case of 6-parameter affine) MVD is further predicted by the 1^{st} MVD. Therefore, the difference between 2^{nd} and 1^{st} MVD instead of the 2^{nd} MVD is signaled in the bitstream, and the difference between 3^{rd} and 1^{st} MVD instead of the 3^{rd} MVD is signaled in the bitstream for the 6-parater affine. Note that inter prediction direction is signaled beforehand to indicate whether it's bi-prediction, uni-prediction from reference picture list 0 or uni-prediction from reference picture list 1.

In VVC, the affine AVMP candidate list size is generated by using the following four types of CPMVP candidate in order:
Inherited affine AMVP candidates that extrapolated from the CPMVs of the neighbor CUs
Constructed affine AMVP candidates CPMVPs that are derived using the translational MVs of the neighbor CUs
Translational MVs from neighboring CUs
Zero MVs

The checking order of inherited affine AMVP candidates is same to the checking order of inherited affine merge candidates. The only difference is that, for AVMP candidate, only the affine CU that has the same reference picture as in current block is considered. No pruning process is applied when inserting an inherited affine motion predictor into the candidate list.

A constructed AMVP candidate is derived from the specified spatial neighbors. The same checking order is used as done in affine merge candidate construction. In addition, reference picture index of the neighboring block is also checked. The first block in the checking order that is inter coded and has the same reference picture as in current CUs is used. There is only one when the current CU is coded with 4-parameter affine mode, and if mv₀ and mv₁ are both available, they are added as one candidate in the affine AMVP list. When the current CU is coded with 6-parameter affine mode, and all three CPMVs are available, then they are added as one candidate in the affine AMVP list. Otherwise, constructed AMVP candidate is set as unavailable.

If affine AMVP list candidates are still less than maximum number after valid inherited affine AMVP candidates and constructed AMVP candidate are inserted, mv₀, mv₁ and mv₂ may be added, in order, as the translational MVs to predict all control point MVs of the current CU, when available. Finally, zero MVs are used to fill the affine AMVP list if the list is still not full.

### Linear Regression Based Affine Merge Candidates

In ECM 6.0, linear regression based affine merge candidate derivation method proposed in Zhang, et al., “EE2-2.1: Regression based affine candidate derivation,” Joint Video Experts Team (JVET) of ITU-T SG 16 WP 3 and ISO/IEC JTC 1/SC 29/WG 11, 27th Meeting: by teleconference, 13-22 Jul. 2022, JVET-AA0107 was adopted. In the proposal, two types of linear regression based affine merge candidates are derived, the non-refined and refined candidates. For both types of candidates, the derivation process is the same with only different sub-block motion information are used as the input. Y (hereinafter “VVC Draft 10”).

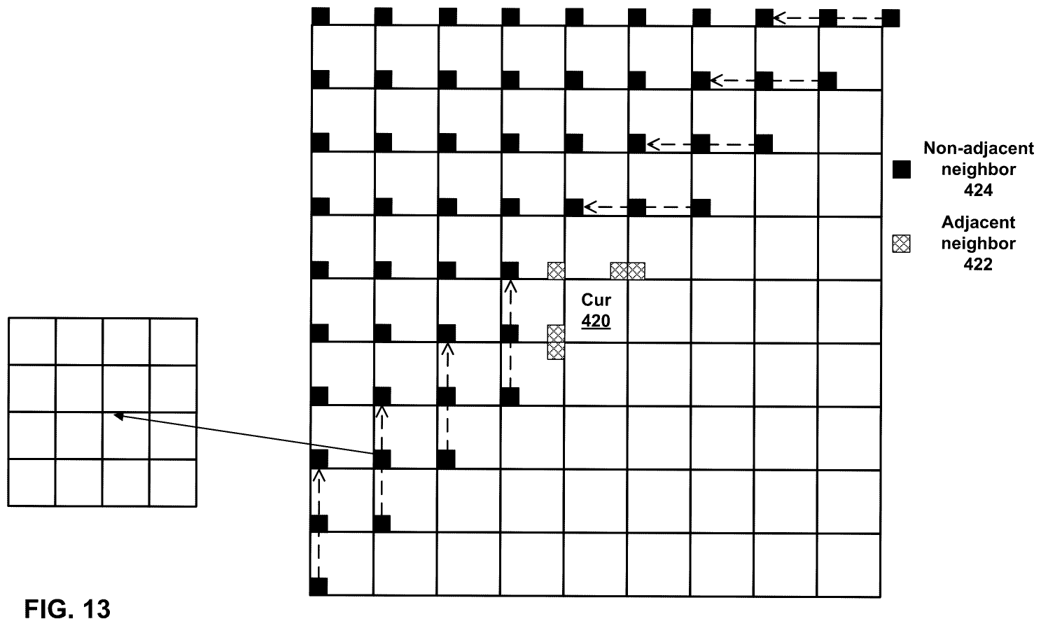

FIG. 13 is a conceptual diagram illustrating example non-adjacent spatial neighboring blocks used to derive non-adjacent affine candidates. In the example of FIG. 13, current block 420 is depicted, along with adjacent neighbors 422 (shown with cross hatching) and non-adjacent neighbors 424 (shown with shading). For the non-refined candidates, only the sub-block motion information from a non-adjacent affine CU is used as the input to the linear regression process. A non-adjacent affine CU would be a non-adjacent neighbor 424 that is coded using affine mode.

FIG. 13 shows an example of inputs to the linear regression process to derive the non-refined linear regression based affine merge candidates. As described above with respect to BDOF, certain scan patterns may be used in searching for non-adjacent affine CUs. Once a non-adjacent affine CU is identified, as in the example of FIG. 12, each of a sub-block's motion information including the sub-block's motion vectors denoted by {(mvₓ₀, mv_{y0}), (mvₓ₁, mv_{y1}), . . . , (mv_{xN-1}, mV_{yN-1})} and central coordinates denoted by {(x₀, y₀), (x₁, y₁), . . . , (x_{N-1}, y_{N-1})} are input to the linear regression process to derive non-refined affine merge candidates.

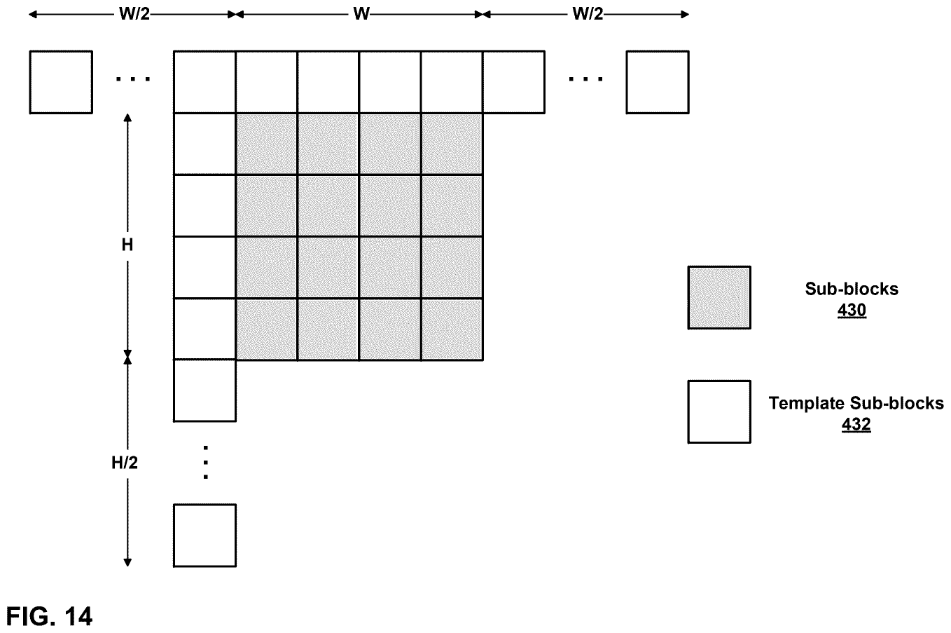

FIG. 14 is a conceptual diagram illustrating an example of sub-block motion information used to derive refined candidates. For the refined candidates, in addition to the motion information from sub-blocks 430 in the non-adjacent affine CU (as shown in FIG. 13), motion information from the template sub-blocks 432 may additionally be included as input to the linear regression process.

The linear regression process for deriving both the non-refined as well as the refined candidates are the same which follows the mathematical derivation as explained above. The only difference is which of the sub-blocks' information should be used as the input to the linear regression process. For example, video encoder 200 or video decoder 300 may employ such a linear regression process for deriving both the non-refined, as well as the refined candidates.

### Bilateral Matching AMVP-Merge Mode in ECM

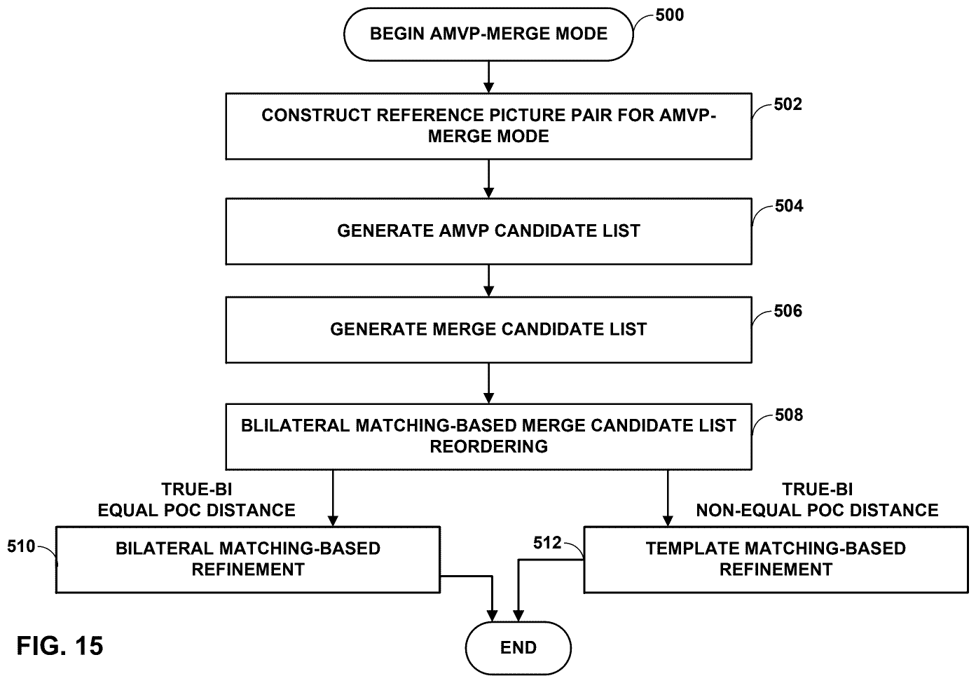

The bi-directional predictor is composed of an AMVP predictor in one direction and a merge predictor in the other direction. The mode can be enabled to a coding block when the selected merge predictor and the AMVP predictor satisfy DMVR condition, where there is at least one reference picture from the past and one reference picture from the future relatively to the current picture and the distances from two reference pictures to the current picture are the same, the bilateral matching MV refinement is applied for the merge MV candidate and AMVP MVP as a starting point. Otherwise, if template matching functionality is enabled, template matching MV refinement is applied to the merge predictor or the AMVP predictor which has a higher template matching cost. The pipeline of AMVP-merge mode is illustrated in FIG. 15.

FIG. 15 is a flowchart illustrating an example of AMVP-merge mode for non-LDC picture techniques. In FIG. 15, the AMVP-merge mode process begins at 500. Then video encoder 200 and video decoder 300 may construct a reference picture pair for the AMVP-merge mode (502). Video encoder 200 and video decoder 300 may generate an AMVP candidate list (504) for one prediction direction, and may generate a merge candidate list (506) for the other prediction direction. In some examples, video encoder 200 and video decoder 300 may perform bilateral matching-based merge candidate list reordering (508) on the AMVP candidate list and/or the merge candidate list. Video encoder 200 and video decoder 300 may perform bilateral matching-based refinement (510) if the candidates have equal POC distance, and may perform template matching-based refinement if the candidates have unequal POC distance (512). The term “true-bi equal POC distance” refers to the situation where one reference picture has a POC that is less than the POC of the current picture, and the other reference picture has a POC that is greater than the POC of the current picture.

The AMVP part of the mode is signaled as a regular uni-directional AMVP, i.e., reference index and MVD are signaled, and it has a derived MVP index if template matching is used or MVP index is signaled when template matching is disabled.

For AMVP direction LX, X can be 0 or 1, the merge part in the other direction (1−LX) is implicitly derived by minimizing the bilateral matching cost between the AMVP predictor and a merge predictor, i.e., for a pair of the AMVP and a merge motion vector. For every merge candidate in the merge candidate list which has that other direction (1-LX) motion vector, the bilateral matching cost is calculated using the merge candidate MV and the AMVP MV. The merge candidate with the smallest cost is selected. The bilateral matching refinement is applied to the coding block with the selected merge candidate MV and the AMVP MV as a starting point.

The third pass of multi pass DMVR which is 8×8 sub-PU BDOF refinement of the multi-pass DMVR is enabled to AMVP-merge mode coded block.

The mode is indicated by a flag, if the mode is enabled AMVP direction LX is further indicated by a flag.

### Local Illumination Compensation (LIC)

LIC is an inter prediction technique to model local illumination variation between a current block and its prediction block as a function of defined between a current block template and a reference block template. The parameters of the function can be denoted by a scale α and an offset β, which forms a linear equation, that is, α*p[x]+β to compensate illumination changes, where p[x] is a reference sample pointed to by MV at a location x on reference picture. Since α and β can be derived based on current block template and reference block template, no signaling overhead is required for them, except that an LIC flag is signaled for AMVP mode to indicate the use of LIC.

The local illumination compensation proposed in Seregin et al, “CE4-3.1a and CE4-3.1b: Unidirectional local illumination compensation with affine prediction,” Joint Video Experts Team (JVET) of ITU-T SG 16 WP 3 and ISO/IEC JTC 1/SC 29/WG 11, 15th Meeting: Gothenburg, 3-12 Jul. 2019, JVET-00066 is used for uni-prediction inter CUs with the following modifications: Intra neighbor samples can be used in LIC parameter derivation; LIC is disabled for blocks with less than 32 luma samples; For both non-subblock and affine modes, LIC parameter derivation is performed based on the template block samples corresponding to the current CU, instead of partial template block samples corresponding to first top-left 16×16 unit; Samples of the reference block template are generated by using MC with the block MV without rounding it to integer-pel precision.

In Xiu et al., “EE2-Test2.7: Improvements on local illumination compensation,” Joint Video Experts Team (JVET) of ITU-T SG 16 WP 3 and ISO/IEC JTC 1/SC 29/WG 11, 30th Meeting: Antalya, 21-28 Apr. 2023, JVET-AD0213, LIC mode is extended to bi-predictive CUs and is adopted into ECM, where two different linear models are applied to the two prediction blocks which are then combined to generate the bi-prediction samples of the current CU, i.e.,

$${P}^{′} [ x , y ] = ( 1 - ω ) \cdot {p}_{0}^{′} [ x , y ] + ω \cdot {p}_{1}^{′} [ x , y ]$$

$$and$$

$$\begin{matrix}{p}_{0}^{′} [ x , y ] = {α}_{0} \cdot {P}_{0} [ x , y ] + {β}_{0} \\ {p}_{1}^{′} [ x , y ] = {α}_{1} \cdot {P}_{1} [ x , y ] + {β}_{1}\end{matrix}$$

where α₀ and β₀, and α₁ and β₁ indicate the scales and the offsets in L0 and L1, respectively; w indicates the weight (as indicated by the CU-level BCW index) for the weighted combination of L0 and L1 predictions.

The method first derives the L0 parameters by minimizing difference between L0 template prediction T₀ and the template T and the samples in T are updated by subtracting the corresponding samples in T₀. Then, the L1 parameters are calculated that minimizes the difference between L1 template prediction T₁ and the updated template. Finally, the L0 parameter is refined again in the same way.

Following the current LIC design, one flag is signaled for AMVP bi-predicted CUs for the indication of the LIC mode while the flag is inherited for merge related inter CUs. Additionally, the LIC is disabled for DMVR and BDOF.

In ECM, the derived LIC model parameter is stored in the CUs since when performing overlapped block motion compensation (OBMC), the LIC model parameter will additionally be compared to decide whether the OBMC need to be performed. Hence, for a CU with LIC flag equals to true, a set of LIC model parameters is stored and available for future usage.

In Xiu et al., “Non-EE2: Enhancements on local illumination compensation,” Joint Video Experts Team (JVET) of ITU-T SG 16 WP 3 and ISO/IEC JTC 1/SC 29/WG 11, 32nd Meeting: Hanover, 13-20 Oct. 2023, JVET-AF0191, non-local illumination compensation (NLIC) is proposed. For this method, instead of using the template samples, the samples of the previously coded CUs are utilized for deriving the linear model used for the motion compensation of the current block. Specifically, after the reconstruction of each inter CU (except for geometry-based prediction mode (GPM) and SbTMVP CUs), one linear model is derived by minimizing the difference between the reconstruction and prediction samples of the block. The derived LIC model parameters are also stored. This LIC model is derived irrespective of the LIC flag value of the block. If the LIC flag is true for the CU, then two set of LIC model parameters are stored. One set is derived between the current template and reference template. Another set is derived by minimizing the difference between the reconstruction and prediction samples of the block. If the LIC flag is false, then only set of LIC parameters are stored which is derived between the reconstruction and prediction samples of the block.

In Zhang et al., “EE2-3.2: LIC flag derivation for merge candidates with template costs,” Joint Video Experts Team (JVET) of ITU-T SG 16 WP 3 and ISO/IEC JTC 1/SC 29/WG 11, 32nd Meeting: Hanover, 13-20 Oct. 2023, JVET-AF0128, a template matching cost based LIC flag derivation method is proposed and is adopted to the ECM reference software. In these techniques, the template matching cost is computed twice for the same merge candidate with LIC flag set to true or false each time. The two template matching costs will be compared, and a predefined threshold is used to decide whether the LIC flag will be modified. Currently this method is only applied to uni-predicted merge candidates.

### Chained Motion Vector Prediction

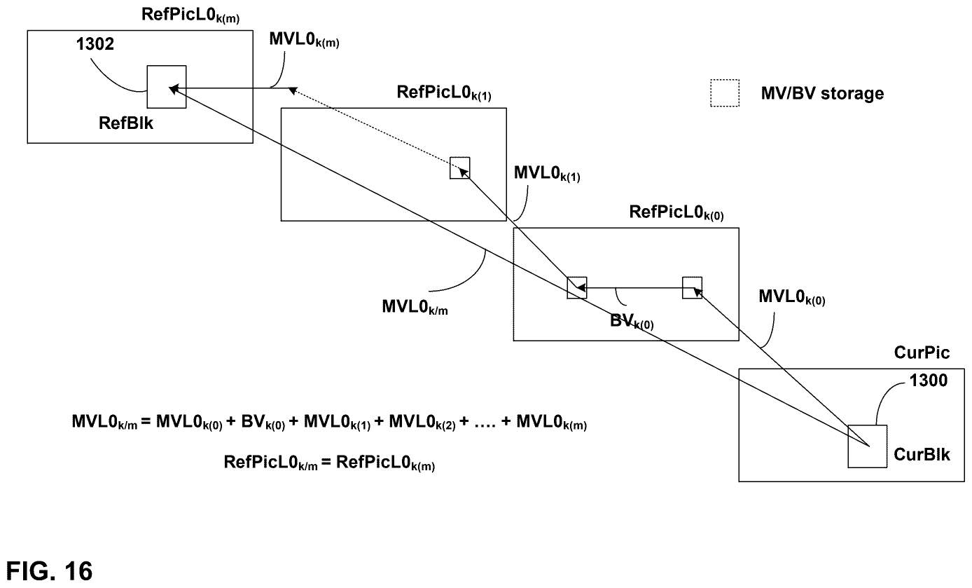

Chained MV prediction (CMVP) is a method to derive the merge candidates in the inter merge candidate list construction. As shown in FIG. 16, CMVP candidates for current block 1300 in the current picture can be derived as the accumulation of the recursively traced MVs (motion vectors) and/or BVs (block vectors) based on the pre-derived MVs (e.g., source vectors) for the inter merge candidate list. For instance, a CMVP candidate, a set of motion vector MV_{k/m} and reference picture RefPic_{k/m} can be derived by

$$\begin{matrix}{MV}_{k / m} = M {V}_{k ( 0 )} + B {V}_{k ( 0 )} + M {V}_{k ( 1 )} + M {V}_{k ( 2 )} + … + {MV}_{k ( m ) ,} \\ {RefPic}_{k / m} = R {efPic}_{k ( m ) ,}\end{matrix}$$

where k and m indicate the number of merge index and trace depths of the CMVP. In FIG. 16, reference block 1302 is pointed to by motion vector MVL0_{k/m}.

In FIG. 16, video encoder 200 or video decoder 300 may accumulate recursively traced motion vectors or block vectors for a trace depth starting from the source vector. In this example, each of the traced motion vectors or block vectors is a motion vector or block vector for a block pointed to by a previous motion vector or block vector of the traced motion vectors or block vectors.

For example, as illustrated in FIG. 16, MVL0ₖ₍₀₎ may be the source vector, and MVL0_{k/m} may be the CMVP candidate. Also, as can be seen in FIG. 16, MVL0ₖ₍₁₎ is a motion vector or block vector for a block that is pointed to by a previous motion vector or block vector (e.g., MVL0ₖ₍₀₎ of the traced motion vectors or block vectors. In this example, the traced motion vectors include MVL0ₖ₍₀₎+BVₖ₍₀₎+MVL0ₖ₍₁₎+MVL0ₖ₍₂₎+ . . . +MVL0ₖ₍ₘ₎. In this example, the trace depth is two, and the recursive accumulation may be MVL0_{k/m}=MVL0ₖ₍₀₎+BVₖ₍₀₎+MVL0ₖ₍₁₎+MVL0ₖ₍₂₎+ . . . +MVL0ₖ₍ₘ₎.

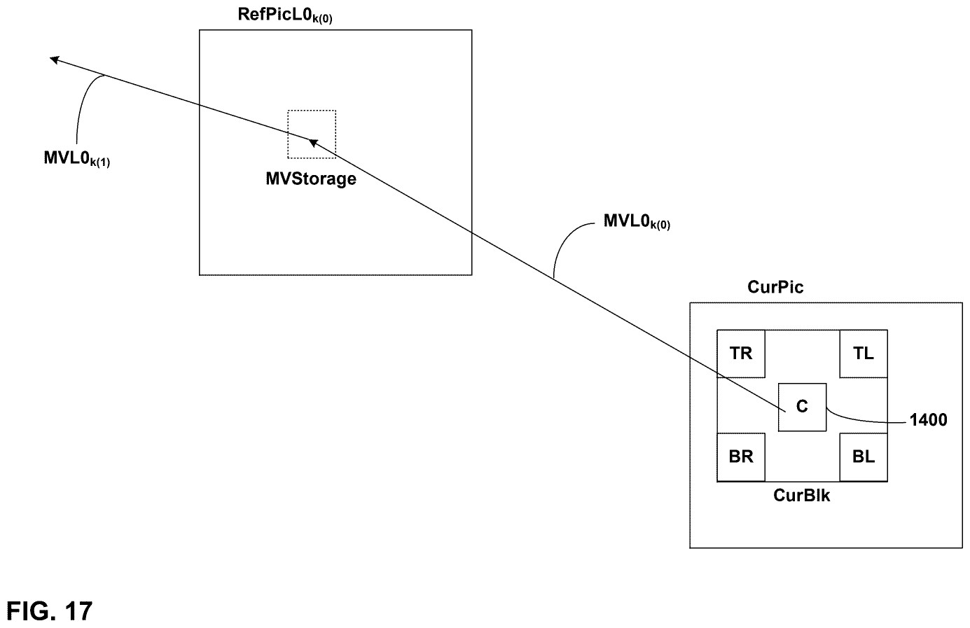

When deriving MV_{k/m}, MVₖ₍ₘ₎ is found by checking the existence of MVs or BVs in MV/BV storage corresponding to all five position of the current block as shown in FIG. 17. For instance, the center, top-left, top-right, bottom-left, and bottom-right of the current block 1400 are checked for MVs or BVs.

When pre-derived merge candidates targeting CMVP candidates has two MVs, a MV_{k/m} is derived for each merge index, each list (i.e., L0 and L1), and each trace depth. Trace depth may refer to the number of vectors that are considered recursively. For instance, in FIG. 16, the trace depth may be “m” (e.g., BVₖ₍₀₎ with RefPicL0ₖ₍₀₎ is at first trace depth, MVL0ₖ₍₁₎ with RefPicL0ₖ₍₁₎ is at second trace depth, and so forth until MVL0ₖ₍ₘ₎ with RefPicL0ₖ₍ₘ₎ being at the m^{th} trace depth). Up to two MVs can be derived for each list and each trace depth, and the MV set is sequentially inserted into inter merge candidate list. The traceable reference pictures are only within the reference picture list.

CMVP candidates are inserted after HMVP candidates for the regular merge and TM merge. When deriving CMVP candidates, hpelIfIdx, bcwIdx, licFlag, and mhpFlag are not inherited. CMVP candidates are not derived when the TMVP is disabled.

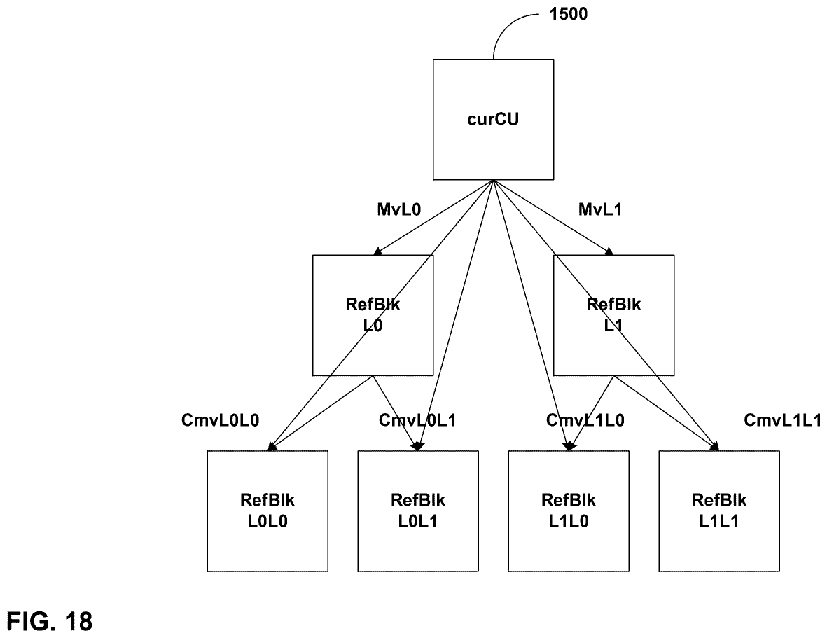

As illustrated in FIG. 18, for current block 1500, if the source motion is bi-prediction, two reference blocks RefBlkL0 and RefBlkL1 are found and at most 4 chained motion vectors could be traced if the both reference blocks are also bi-prediction blocks. That is, current block 1500 is inter-predicted using a first motion vector (MvL0) that points to a first reference block (RefBlk L0) in a first reference picture in reference picture list 0 (L0), and a second motion vector (MvL1) that points to a second reference block (RefBlk L1) in a second reference picture in reference picture list 1 (L1). If RefBlk L0 is inter-predicted with two motion vectors and two reference blocks (e.g., RefBlk L0L0 and RefBlk L0L1), then the are two CMPVs (e.g., CmvL0L0 and CmvL0L1). If RefBlk L1 is inter-predicted with two motion vectors and two reference blocks (e.g., RefBlk L1L0 and RefBlk L1L1), then the are two CMPVs (e.g., CmvL1L0 and CmvL1L1). This leads to a total of four CMPVs: CmvL0L0, CmvL0L1, CmvL1L0, and CmvL1L1.

### EXAMPLES

In the current version of ECM, motion vector prediction for a bi-prediction candidate can be derived from only a spatial MVP or a temporal MVP. Such an approach may not be efficient for all types of content.

The present disclosure addresses these limitations by introducing a hybrid spatial-temporal motion vector prediction framework that combines motion vectors from both spatial and temporal domains to generate a more accurate and efficient motion vector predictor. Unlike conventional methods that rely on either spatial or temporal predictors in isolation, the described approach derives a hybrid motion vector predictor by leveraging the strengths of both domains. Specifically, the hybrid predictor uses a spatial motion vector to locate a co-located block in a reference frame and then derives a temporal motion vector from the co-located block. The motion vectors from these two sources are combined to form a bi-directional motion vector predictor, where one list is derived from the spatial domain and the other from the temporal domain. This hybrid approach enhances motion prediction accuracy, leading to improved compression efficiency and reduced residual data.

The techniques of this disclosure include examples that further extend this concept to subblock-level granularity, enabling the derivation of hybrid spatial-temporal motion vector predictors for each subblock within a coding block. This fine-grained approach may be particularly effective in handling blocks with complex or non-uniform motion patterns. Additionally, the techniques of this disclosure include examples that incorporate advanced techniques such as chained motion vector prediction, where motion vectors are recursively accumulated from multiple reference blocks, and hybrid bi-prediction, which combines derived motion vector predictors with chained motion vector predictors. These advancements provide a robust and scalable framework for motion vector prediction, adaptable to various video coding standards and capable of addressing a wide range of motion scenarios.

### Spatial-Temporal Motion Vector Prediction

In one example of the disclosure, video encoder 200 and video decoder 300 may use a spatial MV related to a block of video data to locate a co-located block in a reference picture. In this context, a spatial motion vector is a motion vector obtained for a current block relative to a motion vector of a neighboring block in the same picture. As explained above, the spatial motion vector may be determined using merge mode, AMVP mode, or other techniques (e.g., history-based motion vector prediction). Video encoder 200 and video decoder 300 may then derive a temporal MV from the co-located block in the reference frame. The temporal motion vector may be the motion vector used to code the co-located block.

To generate a hybrid spatial-temporal motion vector predictor, video encoder 200 and video decoder 300 may derive a MV of one list from the spatial MV. That is, one motion vector of the hybrid spatial-temporal motion vector predictor may be determined from the spatial motion vector. If the spatial motion vector is a single, uni-predicted motion vector, the spatial motion vector is used directly as one motion vector for one list (e.g., list 0 or list 1) of the hybrid spatial-temporal motion vector predictor. If the spatial motion vector is a bi-predicted motion vector, one of the two spatial motion vectors (e.g., from list 0 or list 1) is used directly as one motion vector for one list (e.g., list 0 or list 1) of the hybrid spatial-temporal motion vector predictor.

Video encoder 200 and video decoder 300 also derive a MV of the other list (e.g., the list not using the spatial MV) from the temporal MV or temporal MVP (e.g., an index associated with the co-located block). If the temporal motion vector is a single, uni-predicted motion vector, the temporal motion vector is used directly as one motion vector for the other list (e.g., not using the spatial motion vector) of the hybrid spatial-temporal motion vector predictor. If the temporal motion vector is a bi-predicted motion vector, one of the two temporal motion vectors (e.g., from list 1 or list 0) is used directly as one motion vector for the other list (e.g., not using the spatial motion vector) of the hybrid spatial-temporal motion vector predictor.

As such, for a bi-predicted motion vector according to the techniques of this disclosure, the motion vector for one list (e.g., list 0) is a spatial motion vector, and the motion vector from the other list (e.g., list 1) is a temporal motion vector derived from the spatial motion vector. Accordingly, in one example of the disclosure, video encoder 200 and video decoder 300 may be configured to receive a block to be coded using bi-prediction, and code the block of video data using bi-prediction and a hybrid spatial-temporal motion vector predictor. Video encoder 200 and video decoder 300 may derive the hybrid spatial-temporal motion vector predictor for a first list (e.g., list 0 or list 1) based on a spatial motion vector, and for a second list (e.g., list 1 or list 0) based on a temporal motion vector or temporal motion vector predictor.

In one example, of the disclosure, video encoder 200 and video decoder 300 may receive a block to be coded using bi-prediction, determine a spatial motion vector for the block, determine a temporal motion vector based on the spatial motion vector, generate a hybrid spatial-temporal motion vector based on the spatial motion vector and the temporal motion vector, and code the block of video data using bi-prediction and the hybrid spatial-temporal motion vector. In this context, coding the block of video data using bi-prediction and the hybrid spatial-temporal motion vector may include using the hybrid spatial-temporal motion vector to perform the bi-prediction process. In other examples, coding the block of video data using bi-prediction and the hybrid spatial-temporal motion vector may include inserting the hybrid spatial-temporal motion vector into a candidate list (e.g., a merge candidate list) and determining the bi-prediction motion vector to use from the candidate list.

In one example, when video encoder 200 and video decoder 300 derive the spatial MV from list X (for example, X could be 0 or 1), to generate the hybrid spatial-temporal MVP, the MV of list X is derived from the MV of a spatial neighbor to the current block and the MV of list (1−X) is derived from the temporal MV.

In another example, video encoder 200 and video decoder 300 may derive a spatial MVP (which may include motion vector and reference picture indices) from a neighbor block located in the current picture. Video encoder 200 and video decoder 300 may derive the temporal MVP from a block located in a reference picture, wherein the reference picture is determined by the reference picture indices of the spatial MVP. The co-located block position in the reference picture is determined by the motion vector of the spatial MVP and the position of the current block. In one example, the MV of the temporal MVP is the MV of a block located in the reference picture without MV scaling. In another example, the MV of the temporal MVP is the MV of a block located in the reference picture with MV scaling.

An MVP may include a motion vector and reference picture indices. In the following examples, a spatial MV also refers to the motion vector of a spatial MVP. A temporal MV also refers to the motion vector of a temporal MVP.

In one example, the spatial-temporal MVP is a bi-directional MVP with the following characteristics: listX: a spatial MVP; list1−X: a temporal MVP derived from the motion vectors of the co-located block.

In another example, the spatial-temporal MVP is a bi-directional MVP with the following characteristics: listX: spatial MVP; list1−X: the list (1−X) temporal MVP derived from the motion vectors of the co-located block.

In the above examples, if the list (1−X) temporal MVP is not available, the list X temporal MVP is used or scaled to generate the list (1−X) temporal MVP. In another example, if the temporal MVP only has a list X MV, the list X spatial MV is used or scaled to generate the list (1−X) spatial MVP.

In one example, video encoder 200 and video decoder 300 may derive the spatial MVP from an adjacent spatial neighbor to current block in current picture. In another example, video encoder 200 and video decoder 300 may derive the spatial MVP from a non-adjacent spatial neighbor to current block in current picture. In another example, the spatial MVP has a fixed offset motion vector and a predetermined reference picture index. In another example, video encoder 200 and video decoder 300 may derive the spatial MVP from a merge candidate in a merge candidate list. In another example, video encoder 200 and video decoder 300 may derive the spatial MVP from a merge candidate in merge candidate list X only.

In another example, the spatial MVP is the MV of the neighbor block and the MV points to a reference picture which is the same as the co-located picture. In other words, the spatial MVP is derived from a spatial neighbor block which has a reference picture index that is equal to the picture indices of the co-located picture, wherein a co-located picture index is either predetermined or is signaled in bitstream.

In another example, the motion vector of a spatial MVP is the MV of the neighbor block and the MV points to a reference picture which is not the co-located picture. In this case, the spatial MV is derived as the temporal scaling from the reference picture to the co-located picture and the reference picture index is changed to the picture index of the co-located picture, accordingly.

In another example, the above-described techniques are only applied to certain types of slices, or pictures. In one example, video encoder 200 and video decoder 300 are configured to apply the techniques of this disclosure to only one of more of random access (RA), low delay B (LDB), and low delay P (LDP) slices/pictures.

In another example, video encoder 200 and video decoder 300 are configured to apply the techniques of this disclosure to only certain types of blocks. In one example, the techniques of this disclosure are only applied to blocks larger than a threshold, e.g., 32×32. In another example, the techniques of this disclosure are only applied to square blocks.

In another example, video encoder 200 may signal an index of a flag to video decoder 300 to indicate whether the proposed spatial-temporal MVP is applied.

In another example, the proposed spatial-temporal MVP is included in the merge candidate list. That is, the hybrid spatial-temporal MVP is one candidate in a merge candidate list that may be considered when coding a bi-predicted block.

### Subblock-based Spatial-Temporal Motion Vector Prediction

In this example, video encoder 200 and video decoder 300 may again use a spatial MVP to determine a co-located block. For each N×M subblock of the current block, video encoder 200 and video decoder 300 may derive the temporal MV from the co-located subblock. To generate a hybrid spatial-temporal motion vector prediction for each subblock, video encoder 200 and video decoder 300 may derive the MV of one list from the spatial MVP and derive the MV of the other list from the temporal MVP in the same manner as described above.

Accordingly, video encoder 200 and video decoder 300 may be configured to derive a hybrid spatial-temporal motion vector predictor for each subblock of the block. To derive the hybrid spatial-temporal motion vector predictor for each subblock of the block, video encoder 200 and video decoder 300 may determine a co-located block based on a spatial motion vector, derive, for each subblock, a respective temporal motion vector based on a co-located subblock of the co-located block, and derive the hybrid spatial-temporal motion vector predictor for each subblock of the block from a first list based on the spatial motion vector, and from a second list based on the respective temporal motion vectors.

In one example, when the spatial MVP is derived from list X (for example, X could be 0 or 1), to generate the spatial-temporal MVP, the MV and the reference picture indices of reference picture list X is derived from the spatial MVP and the MV and the reference picture indices of list (1−X) is derived from the temporal MVP.

In one example, the spatial-temporal MVP is a bi-directional MVP with the following characteristics: listX: spatial MVP; list1−X: a temporal MVP derived from the MVP of the co-located subblock.

In another example, the spatial-temporal MVP is a bi-directional MVP with the following characteristics: listX: spatial MV; list1−X: the list (1−X) temporal MVP derived from the motion vectors of the co-located subblock.

In the above example, if the list (1−X) temporal MVP is not available, the list X temporal MVP is used or scaled to generate the list (1−X) temporal MVP.

In another example, if the temporal MVP only has list X MV, the list X spatial MVP is used or scaled (MV scaling and reference picture indices changing accordingly) to generate the list (1−X) spatial MVP.

In one example, the spatial MVP is derived from an adjacent spatial neighbor to current block in current picture. In another example, the spatial MVP is derived from a non-adjacent spatial neighbor to current block in current picture. In one example, the spatial MVP has a fixed offset motion vector and a predetermined reference picture index. In one example, the spatial MVP is derived from a merge candidate in a merging candidate list. In one example, the spatial MVP is derived from a merge candidate in a merging candidate list X only.

In one example, the spatial MVP is the MV of the neighbor block and the MV points to a reference picture which is same as the co-located picture. In other words, the spatial MVP is derived from a spatial neighbor block which has a reference picture index that is equal to the picture indices of the co-located picture, wherein, a co-located picture indices are either predetermined or is signaled in bitstream.

In one example, the motion vector of a spatial MVP is the MV of the neighbor block and the MV points to a reference picture which is not the co-located picture. In this case, the spatial MV is derived as the temporal scaling from the reference picture to the co-located picture and the reference picture indices is changed to the picture indices of the co-located picture accordingly.

In another example, the above-described techniques are only applied to certain types of slices, or pictures. In one example, video encoder 200 and video decoder 300 are configured to apply the techniques of this disclosure to only one of more of random access (RA), low delay B (LDB), and low delay P (LDP) slices/pictures.

In another example, video encoder 200 and video decoder 300 are configured to apply the techniques of this disclosure to only certain types of blocks. In one example, the techniques of this disclosure are only applied to blocks larger than a threshold, e.g., 32×32. In another example, the techniques of this disclosure are only applied to square blocks.

In another example, video encoder 200 may signal an index of a flag to video decoder 300 to indicate whether the proposed spatial-temporal MVP is applied.

In one example, the proposed subblock-based hybrid spatial-temporal motion vector predictor is included in the affine candidate list.

### Subblock-Based Chained Motion Vector Prediction

In this example, video encoder 200 and video decoder 300 may use a spatial MVP to locate a co-located block. For each N×M subblock of the current, video encoder 200 and video decoder 300 may derive the chained motion vector prediction for each subblock as the accumulation of the spatial MV and the MV from the co-located subblock. Examples of chained motion vector prediction are described above with reference to FIG. 16, where the spatial MV is used as the source vector in determining the accumulation.

Accordingly, video encoder 200 and video decoder 300 may receive a block to be coded using inter prediction, determine a motion vector predictor for each subblock of the block using chained motion vector prediction and a spatial motion vector, and code the block of video data using the motion vector predictor. To determine the motion vector predictor for each subblock of the block using chained motion vector prediction and the spatial motion vector, video encoder 200 and video decoder 300 may determine a co-located block based on the spatial motion vector, and accumulate, for each subblock, the spatial motion vector and a subblock motion vector from a co-located subblock of the block.

In another example, when the spatial MVP is derived from list X (for example, X could be 0 or 1), the MV of list X is derived from the spatial MVP and the MV of list (1−X) is derived from the accumulation of the spatial MVP and the temporal MVP (e.g., using chained motion vector prediction as described above).

In one example, the spatial-temporal MVP is a bi-directional MVP with the following characteristics: listX: spatial MV; list1−X: the accumulation of the spatial MV and the temporal MV (e.g., using chained motion vector prediction as described above).

In another example, the spatial-temporal MVP is a bi-directional MVP with the following characteristics: listX: spatial MV; list1−X: the accumulation of the spatial MV and the list (1−X) temporal MV) (e.g., using chained motion vector prediction as described above).

In the above example, if the list (1−X) temporal MVP is not available, the list X temporal MVP is used or scaled to generate the list (1−X) temporal MVP.

In another example, if the temporal MVP only has list X MV, the list X spatial MVP is used or scaled (MV scaling and reference picture indices changing accordingly) to generate the list (1−X) spatial MVP.

In one example, the spatial MVP is derived from an adjacent spatial neighbor to current block in current picture.

In one example, the spatial MVP is derived from a non-adjacent spatial neighbor to current block in current picture.

In one example, the spatial MVP has a fixed offset motion vector and a predetermined reference picture index.

In one example, the spatial MVP is derived from a merge candidate in a merging candidate list.

In one example, the spatial MVP is derived from a merge candidate in a merging candidate list X only.

In one example, the spatial MVP is the MV of the neighbor block and the MV points to a reference picture which is the same as the co-located picture. In other words, the spatial MVP is derived from a spatial neighbor block which has a reference picture index that is equal to the picture indices of the co-located picture, wherein co-located picture indices are either predetermined or is signaled in bitstream.

In one example, the motion vector of a spatial MVP is the MV of the neighbor block and the MV points to a reference picture which is not the co-located picture. In this case, the spatial MV is derived as the temporal scaling from the reference picture to the co-located picture and the reference picture indices is changed to the picture indices of the co-located picture accordingly.

In another example, the above-described techniques are only applied to certain types of slices, or pictures. In one example, video encoder 200 and video decoder 300 are configured to apply the techniques of this disclosure to only one of more of random access (RA), low delay B (LDB), and low delay P (LDP) slices/pictures.

In another example, video encoder 200 and video decoder 300 are configured to apply the techniques of this disclosure to only certain types of blocks. In one example, the techniques of this disclosure are only applied to blocks larger than a threshold, e.g., 32×32. In another example, the techniques of this disclosure are only applied to square blocks.

In another example, video encoder 200 may signal an index of a flag to video decoder 300 to indicate whether the proposed spatial-temporal MVP is applied.

In one example, the proposed subblock based chained motion vector prediction is included in the affine candidate list.

### Hybrid Bi-Prediction Candidate Derivation

In this example, a derived MVP or a merge candidate (e.g., spatial MV) is used to reference a co-located block. Video encoder 200 and video decoder 300 may use the motion of this co-located block to derive the CMVP of the original derived MVP. The original derived MVP (e.g., spatial MV) and its CMVP can be combined to generate a hybrid bi-prediction MVP or merge candidate, in which the MV of one direction is derived from original MVP and the MV of the other direction is derived from its CMVP. This example of the disclosure is similar to the temporal MV example described above, with CMVP taking the place of the temporal MV in the hybrid spatial-temporal motion vector.

Accordingly, video encoder 200 and video decoder 300 may configured to receive a block to be coded using bi-prediction, and code the block of video data using bi-prediction and a hybrid motion vector predictor. Video encoder 200 and video decoder 300 may derive the hybrid motion vector predictor based on a derived motion vector predictor or merge candidate. To derive the hybrid motion vector predictor based on the derived motion vector predictor or the merge candidate, video encoder 200 and video decoder 300 may determine a co-located block based on the derived motion vector predictor or the merge candidate, derive a chained motion vector predictor from motion associated with the co-located block, and combine the derived motion vector predictor and the chained motion vector predictor to generate the hybrid motion vector predictor.

In one example, the hybrid bi-prediction MVP is derived only when the original MVP and its CMVP are both uni-prediction and the original MVP and CMVP are predicted from different directions. In one example, the original MVP is predicted from list L0 and the CMVP is predicted from list L1, and vice versa.

In one example, the hybrid bi-prediction MVP is derived when the original MVP is bi-prediction and its CMVP is uni-prediction. If the CMVP is predicted from LX, the hybrid bi-prediction MVP is combined from the L(1−X) MV of the original MVP and LX MV of the CMVP.

In one example, the hybrid bi-prediction MVP is derived when the original MVP is uni-prediction and its CMVP is bi-prediction. If the original MVP is predicted from LX, the hybrid bi-prediction MVP is combined from the LX MV of the original MVP and L(1−X) MV of the CMVP.

In one example, the hybrid bi-prediction MVP is derived when both the original MVP and CMVP is bi-prediction. In this situation, two hybrid bi-prediction MVPs are derived. One is combined from the LX MV of the original MVP and L(1−X) MV of the CMVP. The other is combined from the L(1−X) MV of the original MVP and LX MV of the CMVP.

In one example, the hybrid bi-prediction candidates are inserted into the candidate list after the CMVP candidates, and before the pairwise merge candidates.

In one example, after the hybrid bi-prediction candidates are derived, these candidates are reordered by the template matching cost or bilateral matching cost.

In one example, the reorder process also reduces the candidate number of hybrid bi-prediction, only the first N hybrid bi-prediction candidates with the minimum template matching cost or bilateral matching cost may be preserved.

In one example, after deriving CMVP candidates and hybrid-prediction candidates, the two groups of candidates are reordered together by the template matching cost.

In one example, the reorder process also reduces the candidate number of hybrid bi-prediction and CMVP, only the first N candidates with the minimum template matching cost may be preserved.

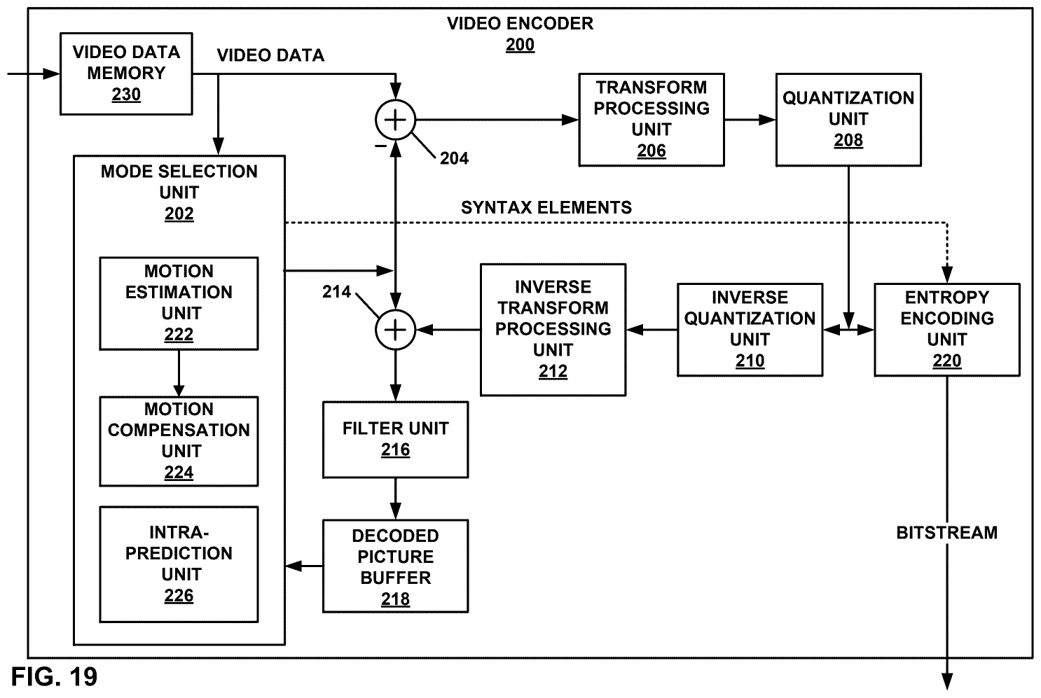

FIG. 19 is a block diagram illustrating an example video encoder 200 that may perform the techniques of this disclosure. FIG. 19 is provided for purposes of explanation and should not be considered limiting of the techniques as broadly exemplified and described in this disclosure. For purposes of explanation, this disclosure describes video encoder 200 according to the techniques of VVC and HEVC. However, the techniques of this disclosure may be performed by video encoding devices that are configured to other video coding standards and video coding formats, such as AV1 and successors to the AV1 video coding format.

In the example of FIG. 19, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 is an example of a memory system that may store video data to be encoded by the components of video encoder 200. Video encoder 200 may receive the video data stored in video data memory 230 from, for example, video source 104 (FIG. 1). DPB 218 is an example of a memory system that may act as a reference picture memory that stores reference video data for use in prediction of subsequent video data by video encoder 200. Video data memory 230 and DPB 218 may each be formed by any of a variety of one or more memory devices or memory units, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 19 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block.

Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to perform any combination of the motion vector predictor derivation techniques of this disclosure.

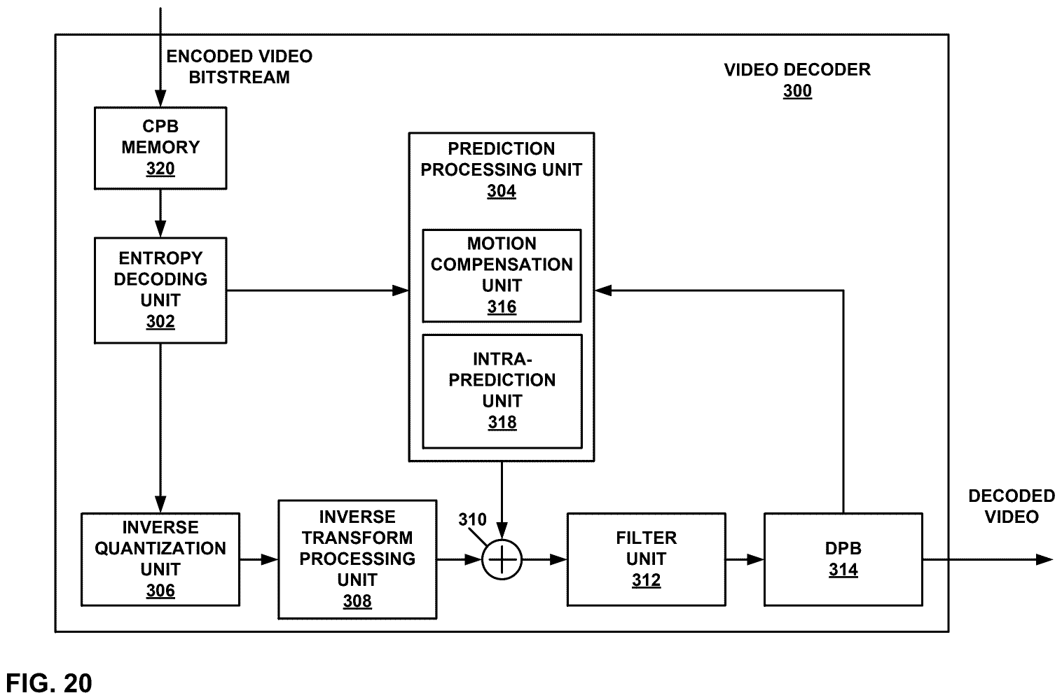

FIG. 20 is a block diagram illustrating an example video decoder 300 that may perform the techniques of this disclosure. FIG. 20 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 20, video decoder 300 includes coded picture buffer (CPB) memory 320, entropy decoding unit 302, prediction processing unit 304, inverse quantization unit 306, inverse transform processing unit 308, reconstruction unit 310, filter unit 312, and DPB 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, IBC, and/or color palette mode, as described above.

CPB memory 320 is an example of a memory system that may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 is an example of a memory system that generally stores decoded pictures, which video decoder 300 may output and/or use as reference video data when decoding subsequent data or pictures of the encoded video bitstream. CPB memory 320 and DPB 314 may each be formed by any of a variety of memory devices or memory units, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 20 are illustrated to assist with understanding the operations performed by video decoder 300. The units may be implemented as fixed-function circuits, programmable circuits, or a combination thereof. Similar to FIG. 19, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 19).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 19). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to perform any combination of the motion vector predictor derivation techniques of this disclosure.

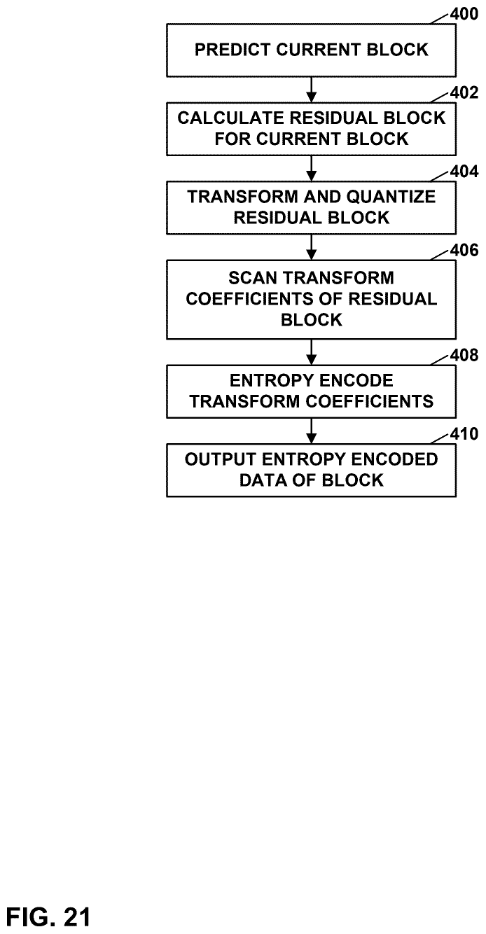

FIG. 21 is a flowchart illustrating an example method for encoding a current block in accordance with the techniques of this disclosure. The current block may be or include a current CU. Although described with respect to video encoder 200 (FIGS. 1 and 19), it should be understood that other devices may be configured to perform a method similar to that of FIG. 21.

In this example, video encoder 200 initially predicts the current block (400). For example, video encoder 200 may form a prediction block for the current block. Video encoder 200 may then calculate a residual block for the current block (402). To calculate the residual block, video encoder 200 may calculate a difference between the original, unencoded block and the prediction block for the current block. Video encoder 200 may then transform the residual block and quantize transform coefficients of the residual block (404). Next, video encoder 200 may scan the quantized transform coefficients of the residual block (406). During the scan, or following the scan, video encoder 200 may entropy encode the transform coefficients (408). For example, video encoder 200 may encode the transform coefficients using CAVLC or CABAC. Video encoder 200 may then output the entropy encoded data of the block (410).

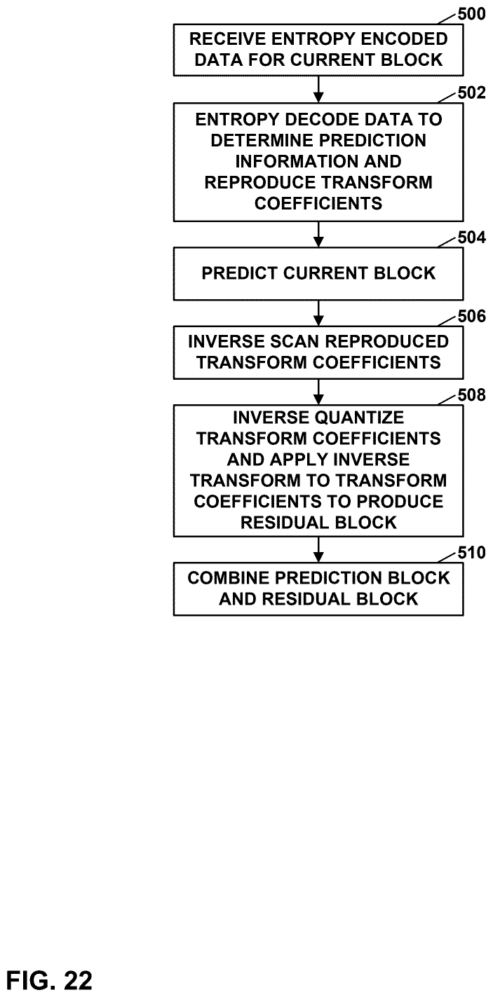

FIG. 22 is a flowchart illustrating an example method for decoding a current block of video data in accordance with the techniques of this disclosure. The current block may be or include a current CU. Although described with respect to video decoder 300 (FIGS. 1 and 20), it should be understood that other devices may be configured to perform a method similar to that of FIG. 22.

Video decoder 300 may receive entropy encoded data for the current block, such as entropy encoded prediction information and entropy encoded data for transform coefficients of a residual block corresponding to the current block (500). Video decoder 300 may entropy decode the entropy encoded data to determine prediction information for the current block and to reproduce transform coefficients of the residual block (502). Video decoder 300 may predict the current block (504), e.g., using an intra- or inter-prediction mode as indicated by the prediction information for the current block, to calculate a prediction block for the current block. Video decoder 300 may then inverse scan the reproduced transform coefficients (506), to create a block of quantized transform coefficients. Video decoder 300 may then inverse quantize the transform coefficients and apply an inverse transform to the transform coefficients to produce a residual block (508). Video decoder 300 may ultimately decode the current block by combining the prediction block and the residual block (510).

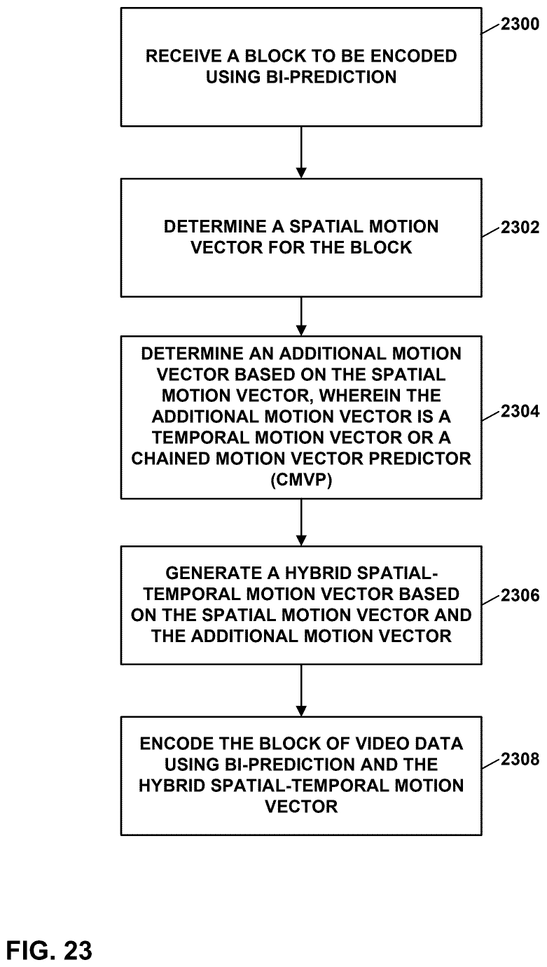

FIG. 23 is a flowchart illustrating another example method for encoding a current block in accordance with the techniques of this disclosure. The techniques of FIG. 23 may be performed by one or more units of video encoder 200, including motion estimation unit 222 and/or motion compensation unit 224.

In one example, video encoder 200 may be configured to receive a block to be encoded using bi-prediction (2300), determine a spatial motion vector for the block (2302), and determine an additional motion vector based on the spatial motion vector, wherein the additional motion vector is a temporal motion vector or a chained motion vector predictor (CMVP) (2304). Video encoder 200 may further be configured to generate a hybrid spatial-temporal motion vector based on the spatial motion vector and the additional motion vector (2306), and encode the block of video data using bi-prediction and the hybrid spatial-temporal motion vector (2308).

In one example, the hybrid spatial-temporal motion vector comprises a first motion vector for a first list based on the spatial motion vector, and a second motion vector for a second list based on the additional motion vector. In one example, the second motion vector is the temporal motion vector and is from the second list of a bi-predicted temporal motion vector.

In a further example, video encoder 200 may be further configured to determine the spatial motion vector for the block from an adjacent spatial neighbor to the block.

In another example, video encoder 200 may be further configured to determine the spatial motion vector for the block from a non-adjacent spatial neighbor to the block.

In another example, to generate the hybrid spatial-temporal motion vector based on the spatial motion vector and the additional motion vector, video encoder 200 is further configured to generate the hybrid spatial-temporal motion vector for each subblock of the block. To generate the hybrid spatial-temporal motion vector for each subblock of the block, video encoder 200 is further configured to determine a co-located block based on the spatial motion vector; derive, for each subblock, a respective additional motion vector based on a co-located subblock of the co-located block, wherein the respective additional motion vector is a respective temporal motion vector or a respective chained motion vector predictor (CMVP), and generate the hybrid spatial-temporal motion vector, for each subblock of the block, from a first list based on the spatial motion vector, and from a second list based on the respective additional motion vector.

In another example, the block is in a random access (RA) picture, low delay B (LDB) picture, or low delay P (LDP) picture. In another example, the block is larger than a threshold.

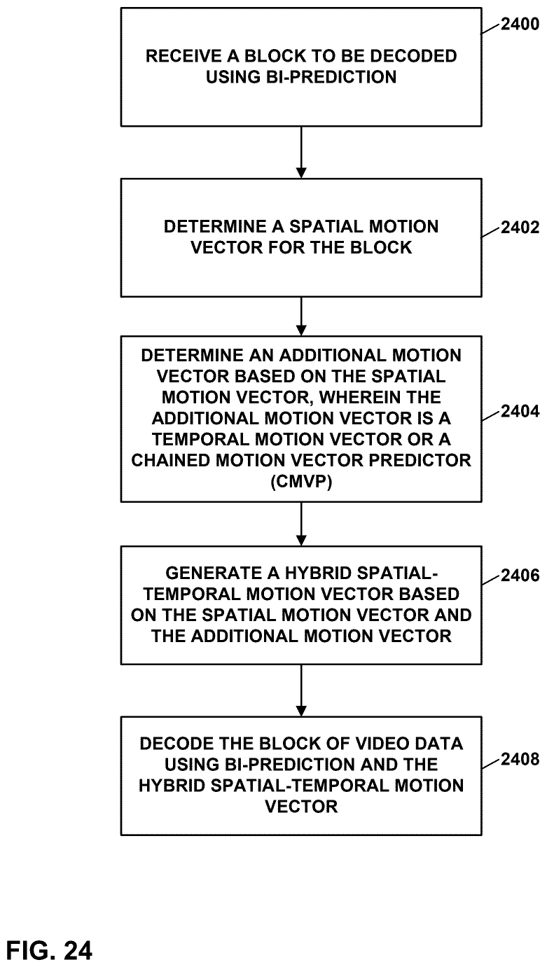

FIG. 24 is a flowchart illustrating another example method for decoding a current block in accordance with the techniques of this disclosure. The techniques of FIG. 24 may be performed by one or more units of video decoder 300, including motion compensation unit 316.

In one example, video decoder 300 may be configured to receive a block to be decoded using bi-prediction (2400), determine a spatial motion vector for the block (2402), and determine an additional motion vector based on the spatial motion vector, wherein the additional motion vector is a temporal motion vector or a chained motion vector predictor (CMVP) (2404). Video decoder 300 may be further configured to generate a hybrid spatial-temporal motion vector based on the spatial motion vector and the additional motion vector (2406), and decode the block of video data using bi-prediction and the hybrid spatial-temporal motion vector (2408).

In one example, the hybrid spatial-temporal motion vector comprises a first motion vector for a first list based on the spatial motion vector, and a second motion vector for a second list based on the additional motion vector. In another example, the second motion vector is the temporal motion vector and is from the second list of a bi-predicted temporal motion vector.

In a further example, video decoder 300 is configured to determine the spatial motion vector for the block from an adjacent spatial neighbor to the block. In another example, video decoder 300 is configured to determine the spatial motion vector for the block from a non-adjacent spatial neighbor to the block.

In another example, to generate the hybrid spatial-temporal motion vector based on the spatial motion vector and the additional motion vector, video decoder 300 is further configured to generate the hybrid spatial-temporal motion vector for each subblock of the block. To generate the hybrid spatial-temporal motion vector for each subblock of the block, video decoder 300 is further configured to determine a co-located block based on the spatial motion vector; derive, for each subblock, a respective additional motion vector based on a co-located subblock of the co-located block, wherein the respective additional motion vector is a respective temporal motion vector or a respective chained motion vector predictor (CMVP), and generate the hybrid spatial-temporal motion vector, for each subblock of the block, from a first list based on the spatial motion vector, and from a second list based on the respective additional motion vector.

In one example, the block is in a random access (RA) picture, low delay B (LDB) picture, or low delay P (LDP) picture. In another example, the block is larger than a threshold.

The following numbered clauses illustrate one or more aspects of the devices and techniques described in this disclosure.
Aspect 1A. A method of coding video data, the method comprising: receiving a block to be coded using bi-prediction; and coding the block of video data using bi-prediction and a hybrid spatial-temporal motion vector predictor.
Aspect 2A. The method of Aspect 1A, further comprising: deriving the hybrid spatial-temporal motion vector predictor from a first list based on a spatial motion vector, and from a second list based on a temporal motion vector or temporal motion vector predictor.
Aspect 3A. The method of Aspect 1A, further comprising: deriving the hybrid spatial-temporal motion vector predictor for each subblock of the block.
Aspect 4A. The method of Aspect 3A, wherein deriving the hybrid spatial-temporal motion vector predictor for each subblock of the block comprises: determining a co-located block based on a spatial motion vector; deriving, for each subblock, a respective temporal motion vector based on a co-located subblock of the co-located block; and deriving the hybrid spatial-temporal motion vector predictor for each subblock of the block from a first list based on the spatial motion vector, and from a second list based on the respective temporal motion vectors.
Aspect 5A. A method of coding video data, the method comprising: receiving a block to be coded using inter prediction; determining a motion vector predictor for each subblock of the block using chained motion vector prediction and a spatial motion vector; and coding the block of video data using the motion vector predictor.
Aspect 6A. The method of Aspect 5A, wherein determining the motion vector predictor for each subblock of the block using chained motion vector prediction and the spatial motion vector comprises: determining a co-located block based on the spatial motion vector; and accumulating, for each subblock, the spatial motion vector and a subblock motion vector from a co-located subblock of the block.
Aspect 7A. A method of coding video data, the method comprising: receiving a block to be coded using bi-prediction; and coding the block of video data using bi-prediction and a hybrid motion vector predictor.
Aspect 8A. The method of Aspect 7A, further comprising: deriving the hybrid motion vector predictor based on a derived motion vector predictor or merge candidate.
Aspect 9A. The method of Aspect 8A, wherein deriving the hybrid motion vector predictor based on the derived motion vector predictor or the merge candidate comprises: determining a co-located block based on the derived motion vector predictor or the merge candidate; deriving a chained motion vector predictor from motion associated with the co-located block; and combining the derived motion vector predictor and the chained motion vector predictor to generate the hybrid motion vector predictor.
Aspect 10A. The method of any of Aspects 1A-9A, wherein coding comprises decoding.
Aspect 11A. The method of any of Aspects 1A-9A, wherein coding comprises encoding.
Aspect 12A. A device for coding video data, the device comprising one or more means for performing the method of any of Aspects 1A-11A.
Aspect 13A. The device of Aspect 12A, wherein the one or more means comprise one or more processors implemented in circuitry.
Aspect 14A. The device of any of Aspects 12A and 13A, further comprising a memory to store the video data.
Aspect 15A. The device of any of Aspects 12A-14A, further comprising a display configured to display decoded video data.
Aspect 16A. The device of any of Aspects 12A-15A, wherein the device comprises one or more of a camera, a computer, a mobile device, a broadcast receiver device, or a set-top box.
Aspect 17A. The device of any of Aspects 12A-16A, wherein the device comprises a video decoder.
Aspect 18A. The device of any of Aspects 12A-17A, wherein the device comprises a video encoder.
Aspect 19A. A computer-readable storage medium having stored thereon instructions that, when executed, cause one or more processors to perform the method of any of Aspects 1A-11A.
Aspect 1B. A method of decoding video data, the method comprising: receiving a block to be decoded using bi-prediction; determining a spatial motion vector for the block; determining an additional motion vector based on the spatial motion vector, wherein the additional motion vector is a temporal motion vector or a chained motion vector predictor (CMVP); generating a hybrid spatial-temporal motion vector based on the spatial motion vector and the additional motion vector; and decoding the block of video data using bi-prediction and the hybrid spatial-temporal motion vector.
Aspect 2B. The method of Aspect 1B, wherein the hybrid spatial-temporal motion vector comprises a first motion vector for a first list based on the spatial motion vector, and a second motion vector for a second list based on the additional motion vector.
Aspect 3B. The method of Aspect 2B, wherein the second motion vector is the temporal motion vector and is from the second list of a bi-predicted temporal motion vector.
Aspect 4B. The method of any of Aspects 1B-3B, further comprising: determining the spatial motion vector for the block from an adjacent spatial neighbor to the block.
Aspect 5B. The method of any of Aspects 1B-3B, further comprising:
determining the spatial motion vector for the block from a non-adjacent spatial neighbor to the block.
Aspect 6B. The method of any of Aspects 1B-5B, wherein generating the hybrid spatial-temporal motion vector based on the spatial motion vector and the additional motion vector comprises: generating the hybrid spatial-temporal motion vector for each subblock of the block.
Aspect 7B. The method of Aspect 6B, wherein generating the hybrid spatial-temporal motion vector for each subblock of the block comprises: determining a co-located block based on the spatial motion vector; deriving, for each subblock, a respective additional motion vector based on a co-located subblock of the co-located block, wherein the respective additional motion vector is a respective temporal motion vector or a respective chained motion vector predictor (CMVP); and generating the hybrid spatial-temporal motion vector, for each subblock of the block, from a first list based on the spatial motion vector, and from a second list based on the respective additional motion vector.
Aspect 8B. The method of any of Aspects 1B-7B, wherein the block is in a random access (RA) picture, low delay B (LDB) picture, or low delay P (LDP) picture.
Aspect 9B. The method of any of Aspects 1B-8B, wherein the block is larger than a threshold.
Aspect 10B. An apparatus configured to decode video data, the apparatus comprising: a memory; and processing circuitry in communication with the memory, the processing circuitry configured to: receive a block to be decoded using bi-prediction; determine a spatial motion vector for the block; determine an additional motion vector based on the spatial motion vector, wherein the additional motion vector is a temporal motion vector or a chained motion vector predictor (CMVP); generate a hybrid spatial-temporal motion vector based on the spatial motion vector and the additional motion vector; and decode the block of video data using bi-prediction and the hybrid spatial-temporal motion vector.
Aspect 11B. The apparatus of Aspect 10B, wherein the hybrid spatial-temporal motion vector comprises a first motion vector for a first list based on the spatial motion vector, and a second motion vector for a second list based on the additional motion vector.
Aspect 12B. The apparatus of Aspect 11B, wherein the second motion vector is the temporal motion vector and is from the second list of a bi-predicted temporal motion vector.
Aspect 13B. The apparatus of any of Aspects 10B-12B, wherein the processing circuitry is further configured to: determine the spatial motion vector for the block from an adjacent spatial neighbor to the block.
Aspect 14B. The apparatus of any of Aspects 10B-12B, wherein the processing circuitry is further configured to: determine the spatial motion vector for the block from a non-adjacent spatial neighbor to the block.
Aspect 15B. The apparatus of any of Aspects 10B-14B, wherein to generate the hybrid spatial-temporal motion vector based on the spatial motion vector and the additional motion vector, the processing circuitry is further configured to: generate the hybrid spatial-temporal motion vector for each subblock of the block.
Aspect 16B. The apparatus of Aspect 15B, wherein to generate the hybrid spatial-temporal motion vector for each subblock of the block, the processing circuitry is further configured to: determine a co-located block based on the spatial motion vector; derive, for each subblock, a respective additional motion vector based on a co-located subblock of the co-located block, wherein the respective additional motion vector is a respective temporal motion vector or a respective chained motion vector predictor (CMVP); and generate the hybrid spatial-temporal motion vector, for each subblock of the block, from a first list based on the spatial motion vector, and from a second list based on the respective additional motion vector.
Aspect 17B. The apparatus of any of Aspects 10B-16B, wherein the block is in a random access (RA) picture, low delay B (LDB) picture, or low delay P (LDP) picture.
Aspect 18B. The apparatus of any of Aspects 10B-17B, wherein the block is larger than a threshold.
Aspect 19B. An apparatus configured to encode video data, the apparatus comprising: a memory; and processing circuitry in communication with the memory, the processing circuitry configured to: receive a block to be encoded using bi-prediction; determine a spatial motion vector for the block; determine an additional motion vector based on the spatial motion vector, wherein the additional motion vector is a temporal motion vector or a chained motion vector predictor (CMVP); generate a hybrid spatial-temporal motion vector based on the spatial motion vector and the additional motion vector; and encode the block of video data using bi-prediction and the hybrid spatial-temporal motion vector.
Aspect 20B. The apparatus of Aspect 19B, wherein the hybrid spatial-temporal motion vector comprises a first motion vector for a first list based on the spatial motion vector, and a second motion vector for a second list based on the additional motion vector.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
receiving a block to be decoded using bi-prediction;
determining a spatial motion vector for the block;
determining an additional motion vector based on the spatial motion vector, wherein the additional motion vector is a temporal motion vector or a chained motion vector predictor (CMVP);
generating a hybrid spatial-temporal motion vector based on the spatial motion vector and the additional motion vector; and
decoding the block of video data using bi-prediction and the hybrid spatial-temporal motion vector.

2. The method of claim 1, wherein the hybrid spatial-temporal motion vector comprises a first motion vector for a first list based on the spatial motion vector, and a second motion vector for a second list based on the additional motion vector.

3. The method of claim 2, wherein the second motion vector is the temporal motion vector and is from the second list of a bi-predicted temporal motion vector.

4. The method of claim 1, further comprising:
determining the spatial motion vector for the block from an adjacent spatial neighbor to the block.

5. The method of claim 1, further comprising:
determining the spatial motion vector for the block from a non-adjacent spatial neighbor to the block.

6. The method of claim 1, wherein generating the hybrid spatial-temporal motion vector based on the spatial motion vector and the additional motion vector comprises:
generating the hybrid spatial-temporal motion vector for each subblock of the block.

7. The method of claim 6, wherein generating the hybrid spatial-temporal motion vector for each subblock of the block comprises:
determining a co-located block based on the spatial motion vector;
deriving, for each subblock, a respective additional motion vector based on a co-located subblock of the co-located block, wherein the respective additional motion vector is a respective temporal motion vector or a respective chained motion vector predictor (CMVP); and
generating the hybrid spatial-temporal motion vector, for each subblock of the block, from a first list based on the spatial motion vector, and from a second list based on the respective additional motion vector.

8. The method of claim 1, wherein the block is in a random access (RA) picture, low delay B (LDB) picture, or low delay P (LDP) picture.

9. The method of claim 1, wherein the block is larger than a threshold.

10. An apparatus configured to decode video data, the apparatus comprising:
a memory; and
processing circuitry in communication with the memory, the processing circuitry configured to:
receive a block to be decoded using bi-prediction;
determine a spatial motion vector for the block;
determine an additional motion vector based on the spatial motion vector, wherein the additional motion vector is a temporal motion vector or a chained motion vector predictor (CMVP);
generate a hybrid spatial-temporal motion vector based on the spatial motion vector and the additional motion vector; and
decode the block of video data using bi-prediction and the hybrid spatial-temporal motion vector.

11. The apparatus of claim 10, wherein the hybrid spatial-temporal motion vector comprises a first motion vector for a first list based on the spatial motion vector, and a second motion vector for a second list based on the additional motion vector.

12. The apparatus of claim 11, wherein the second motion vector is the temporal motion vector and is from the second list of a bi-predicted temporal motion vector.

13. The apparatus of claim 10, wherein the processing circuitry is further configured to:
determine the spatial motion vector for the block from an adjacent spatial neighbor to the block.

14. The apparatus of claim 10, wherein the processing circuitry is further configured to:
determine the spatial motion vector for the block from a non-adjacent spatial neighbor to the block.

15. The apparatus of claim 10, wherein to generate the hybrid spatial-temporal motion vector based on the spatial motion vector and the additional motion vector, the processing circuitry is further configured to:
generate the hybrid spatial-temporal motion vector for each subblock of the block.

16. The apparatus of claim 15, wherein to generate the hybrid spatial-temporal motion vector for each subblock of the block, the processing circuitry is further configured to:
determine a co-located block based on the spatial motion vector;
derive, for each subblock, a respective additional motion vector based on a co-located subblock of the co-located block, wherein the respective additional motion vector is a respective temporal motion vector or a respective chained motion vector predictor (CMVP); and
generate the hybrid spatial-temporal motion vector, for each subblock of the block, from a first list based on the spatial motion vector, and from a second list based on the respective additional motion vector.

17. The apparatus of claim 10, wherein the block is in a random access (RA) picture, low delay B (LDB) picture, or low delay P (LDP) picture.

18. The apparatus of claim 10, wherein the block is larger than a threshold.

19. An apparatus configured to encode video data, the apparatus comprising:
a memory; and
processing circuitry in communication with the memory, the processing circuitry configured to:
receive a block to be encoded using bi-prediction;
determine a spatial motion vector for the block;
determine an additional motion vector based on the spatial motion vector, wherein the additional motion vector is a temporal motion vector or a chained motion vector predictor (CMVP);
generate a hybrid spatial-temporal motion vector based on the spatial motion vector and the additional motion vector; and
encode the block of video data using bi-prediction and the hybrid spatial-temporal motion vector.

20. The apparatus of claim 19, wherein the hybrid spatial-temporal motion vector comprises a first motion vector for a first list based on the spatial motion vector, and a second motion vector for a second list based on the additional motion vector.
